(19) United States
(12) Patent Application Publication
(10) Pub. No.: US 2023/0377034 A1
(43) Pub. Date: Nov. 23, 2023

(54) INTERACTIVE BANKING USING MULTIPLE CHECKING ACCOUNTS

(71) Applicant: Wells Fargo Bank, N.A., San Francisco, CA (US)

(72) Inventors: Deborah M. Ball, San Francisco, CA (US); Susanne Carr, Oakland, CA (US); Stephen M. Ellis, Tahoe City, CA (US); Lei Han, San Francisco, CA (US); Margaret Mangot, San Francisco, CA (US); Stanislav Roumiantsev, Albany, CA (US); Abhijit Shetti, Pleasanton, CA (US); Brad J. Shoff, San Francisco, CA (US)

(73) Assignee: Wells Fargo Bank, N.A., San Francisco, CA (US)

(21) Appl. No.: 18/229,061

(22) Filed: Aug. 1, 2023

Related U.S. Application Data
(63) Continuation of application No. 16/417,404, filed on May 20, 2019.
Application No. 16/417,404 is a continuation-in-part of application No. 16/044,370, filed on Jul. 24, 2018, now Pat. No. 11,574,359.
(60) Provisional application No. 62/536,805, filed on Jul. 25, 2017.

(51) Int. Cl. G06Q 40/02; G06Q 50/18

(52) U.S. Cl. CPC G06Q 40/02; G06Q 50/188

(57) ABSTRACT

A provider institution computing system includes an account management circuit that is configured to perform operations including: associating a first expense with a first envelope of a plurality of envelopes and a second expense with a second envelope of the plurality of envelopes; generating a first payment token and a second payment token; storing the first payment token and the second payment token in the accounts database; and mapping the first payment token and the second payment token to a first account, whereby the first payment token is assigned to the first envelope and the second payment token is assigned to the second envelope. The first payment token is configured to facilitate a payment from the first account via the first envelope to the first payee and the second payment token is configured to facilitate a payment from the first account via the second envelope to the second payee.

### CROSS REFERENCE TO RELATED APPLICATIONS

This application is a continuation of U.S. patent application Ser. No. 16/417,404, entitled “Interactive Banking using Multiple Checking Accounts,” filed May 20, 2019, which is a continuation-in-part of U.S. application Ser. No. 16/044,370, entitled “Interactive Banking Using Multiple Checking Accounts,” filed Jul. 24, 2018, which claims priority to U.S. Provisional Patent Application No. 62/536,805 entitled “Interactive Banking Using Multiple Checking Accounts,” filed Jul. 25, 2017, the contents of which are incorporated by reference herein in their entireties.

### BACKGROUND

Many customers look for more from their financial institutions than the maintenance of checking and savings accounts. For example, customers may seek guidance relating to budgeting their funds between various expenses. Unfortunately, it is oftentimes difficult for customers to receive such services. This is especially the case for new customers, who must first register for a new account, await approval, and then identify how to receive any additional services desired from the financial institution either themselves or through contacting the financial institution directly. This is especially true for the underbanked or those that are new to banking (e.g., college graduates) who are seeking budgeting advice in combination with credit-building guidance. Thus, it would be beneficial to provide an integrated customer onboarding experience enabling a customer to both register for an account as well as additional services in a convenient manner.

### SUMMARY

One embodiment relates to a provider institution computing system associated with a provider institution. The provider institution computing system includes a network interface configured to communicate data over a network. The provider institution computing system also includes an accounts database configured to store information regarding a plurality of accounts associated with a plurality of customers of the financial institution. The provider institution computing system also includes an account management circuit configured to receive, by the network interface, a customer request to establish an account at the provider institution. In response to receiving the customer request, the account management circuit is also configured to create first and second checking accounts for the customer, the first checking account having a first and second envelope therewith, the second checking account having a payment card associated therewith. The account management circuit is also configured to receive, by the network interface, information regarding a funding amount for the first and second payment accounts. The account management circuit is also configured to receive, by the network interface, information regarding a first expense of the customer. The account management circuit is also configured to fund the first envelope with a first portion of the funding amount based on the information regarding the first expense. The account management circuit is further configured to determine a first payment method and assign the first payment method to the first envelope. The account management circuit is further configured to receive information regarding a second expense of the customer, fund the second envelope with a second portion of the funding amount based on the information regarding the second expense, and determine a second payment method for the second envelope.

Another embodiment relates to a computer-implemented method. The method includes determining, by a financial institution computing system, a target goal for a user. The method also includes determining, by the financial institution computing system, a way of achieving the target goal for the user. The method also includes coaching, by the financial institution computing system, the user to achieve the target goal based on the determined way of achieving the target goal. In some embodiments, the determination of the target goal may be done automatically by determining that the credit score of the user is below a threshold or may be determined by receiving a goal from the customer device. In some embodiments, the determination of the way of achieving the target goal includes analyzing financial accounts of the user, determining a target utilization for the user, determining a credit utilization for the user, comparing the target utilization to the credit utilization, and in response to the target utilization being lower than the credit utilization, determining the way of achieving the target goal for the user. In some embodiments, the way of achieving the target goal includes the user lowering the credit utilization of the user to the target utilization via utilizing specific funds in one of the financial accounts to pay down debt. In some embodiments, the coaching of the user may include monitoring transactions in the financial accounts of the user and sending a notification to the customer device based on the transactions and the target utilization.

Another embodiment relates to a computer-implemented method. The method includes determining, by a financial institution computing system, a bill associated with a customer account for renegotiation, requesting, by the financial institution computing system, a renegotiation of the bill associated with the customer, and providing, by the financial institution computing system to a customer device, a notification of the renegotiation to be displayed on a customer device. In some embodiments, the determination of the bill for renegotiation includes analyzing a price of the bill and comparing the price of the bill to a threshold, wherein the threshold is based on industry averages for a geographical location, and wherein the geographical location includes the location of a home address of the customer. In some embodiments the requesting the renegotiation of the bill includes transmitting information associated with the bill to a third party bill negotiation service and receiving results of the renegotiation. In some embodiments, the notification includes an amount saved and a recommendation of where the amount should be allocated.

### BRIEF DESCRIPTION OF THE DRAWINGS

FIG. 1 is a block diagram of an account management system, according to an example embodiment.

FIG. 2 is a flow diagram of a method of creating a personalized checking account for a customer, according to an example embodiment.

FIGS. 3A-3M are graphical user interfaces presented to a customer during a registration for a personalized checking account, according to various example embodiments.

FIG. 4 is a flow diagram of a method of allocating customer funds between a customer spending account and a customer reserve account, according to an example embodiment.

FIGS. 5A-5K are graphical user interfaces enabling a customer to manage an account, according to various example embodiments.

FIG. 6 is a flow diagram of a method of allocating a customer deposit, according to an example embodiment.

FIGS. 7A-7F are graphical user interfaces presented to a customer to assist the customer in the management of funds, according to various example embodiments.

FIG. 8 is a flow diagram of a method of monitoring the financial activity of a customer and providing recommendations to the customer, according to an example embodiment.

FIGS. 9A-9D are graphical user interfaces configured to notify the customer of a recommendation, according to various example embodiments.

FIG. 10 is method of bill renegotiation, according to an example embodiment.

FIG. 11 is method of coaching a customer to reach a target goal, according to an example embodiment.

FIG. 12A is a graphical user interface configured to display a plurality of envelopes in a checking account, according to an example embodiment.

FIG. 12B is a graphical user interface configured display a preferences page for an envelope, according to an example embodiment.

FIG. 13 is a graphical user interface of a dashboard on a user device, according to an example embodiment.

FIG. 14 depicts a flow diagram of a process allocating deposits of the multi-account configuration, according to an example embodiment.

### DETAILED DESCRIPTION

Before turning to the Figures, which illustrate example embodiments, it should be understood that this application is not limited to the details or methodology set forth in the following description or illustrated in the figures. It should also be understood that the phraseology and terminology employed herein is for the purpose of description only and should not be regarded as limiting.

Various embodiments discussed herein relate to systems and methods for providing customers with personalized financial accounts. In various embodiments, a customer of a financial institution downloads and installs a native application onto their device (e.g., a smartphone). Upon installation on the customer device, the native application is structured to cause the customer device to present the customer with a series of registration interfaces configured to receive information from the customer and transmit the information to a financial institution computing system associated with a financial institution. Using the information, the financial institution computing system verifies the customer and generates two or more checking accounts for the customer. In an example implementation, the financial institution computing system generates two checking accounts for the customer: a customer spending account (i.e., a “spending or spend account”) and a customer reserve account (i.e., a “set aside” account). The “set aside” account is to set-aside money for recurring bills and other protected money. The “spending” account is for day-to-day spending that is tied to the customer's payment card (e.g., debit card). In such an implementation, the customer spending account has a payment card associated therewith while the customer reserve account does not have a payment card associated therewith. In various embodiments, the financial institution computing system is configured to receive additional information regarding a funding amount for the spending and reserve accounts as well as expenses of the customer. Based on the expenses of the customer, the financial institution computing system allocates customer funds between the customer spending account and the customer reserve account.

Additionally, the native application on the customer device is configured to make recommendations to the customer based on the allocation of the customer's funds and the customer's financial behaviors. For example, the financial institution computing system may monitor the customer's utilization of funds allocated to the customer's spending account (e.g., an average amount the customer spends per week) to determine that the customer's spending is below a predetermined threshold (e.g., a spending limit previously established by the customer). That is, in one example, the customer may select via the application a (weekly, monthly, yearly, etc.) spending limit that's tied to their debit card. The spending limit is then used as the predetermined threshold for the account management circuit 124 to monitor the customer's spending, and/or deposit funds into the customer's spend account from the customer reserve account. In response to making such a determination, the financial institution computing system may provide a recommendation that the customer set aside some funds for investment or savings. As such, the systems and methods herein provide personalized recommendations based on the customer's individual spending behaviors.

The embodiments and implementations of the systems and methods disclosed herein propose a novel account registration and activation sequence in which a customer is able to establish multiple checking accounts by providing a single input to a financial institution computing system. Technically and beneficially, such a multi-account structure facilitates the presentation of various graphical user interfaces to the customer enabling the customer to monitor and manage the customer's finances. To illustrate, a graphical user interface may include a first portion including a representation of a current funding level of the customer spending account in relation to a spending limit provided by the customer and a second portion indicating a funding level of the customer reserve account. As such, the customer is made aware of both the customer's current spending level as well as a total amount of funds available in an understandable manner.

Additionally, such a multi-account structure facilitates the financial institution providing guidance to improve the financial health of the customer. In various embodiments, the customer's access to funds placed in the customer reserve account is restricted. For example funds placed in the customer reserve account may only be available for payment of a certain subset of customer expenses (e.g., the customer's utility bills). These restrictions ensure that a consistent amount of customer funds remain available for the payment of such customer expenses. Additionally, such a process facilitates the presentation of expense information to the customer. For example, on a graphical user interface, each customer expense may have a payment envelope associated therewith. Each envelope may include an amount owed by the customer by a certain date as well as an adjustable allocation amount. In various embodiments, the systems and methods disclosed herein provide suggested allocation amounts to the customer and dynamically update the envelopes in accordance with allocation inputs provided by the customer. As such, the systems and methods herein provide a unique platform for customers to micro-manage both incoming funds and expenses.

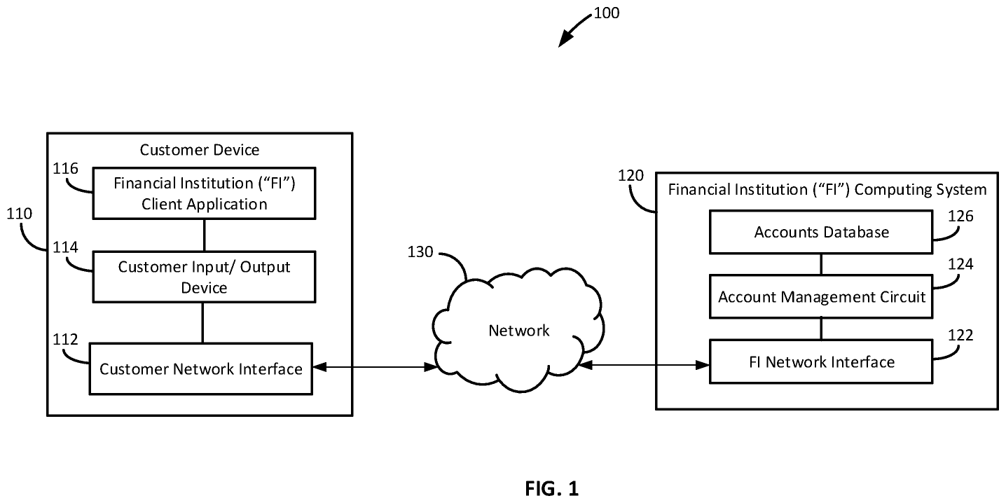

Referring now to FIG. 1, a block diagram of an account management system 100 is shown, according to an example embodiment. The account management system 100 includes a customer device 110 associated with a customer. The customer may be an individual or any other entity capable of opening up an account at a financial institution. The account activation system 100 further includes a financial institution computing system 120 (e.g., provider institution computing system) associated with the financial institution. The financial institution (e.g., provider institution) may include commercial or private banks, credit unions, investment brokerages, or the like. Various components of the account management system 100 are configured to communicate with one another over a network 130. The network 130 is a data exchange medium, which may include wireless networks (e.g., cellular networks, Bluetooth®, WiFi, Zigbee®, etc.), wired networks (e.g., Ethernet, DSL, cable, fiber-based, etc.), or a combination thereof. In some embodiments, the network 130 includes the internet. As described herein, the account management system 100 may be used to enable the customer to establish and fund accounts at the financial institution, engage in various transactions using the established accounts, and receive financial guidance.

The customer device 110 is a computing device associated with the customer. In various embodiments, the customer may utilize the customer device 110 to register for accounts at the financial institution and view various graphical user interfaces containing information pertaining to the customer's accounts. Examples of the customer device 110 include, for example, personal computing devices such as a desktop or a laptop computer, and mobile computing devices such as smartphones, tablets, and wearable computing devices such as smartwatches and the like.

In the example shown, the customer device 110 includes a customer network interface 112 configured to communicate data over the network 130, a customer I/O device 114, and a financial institution client application 116. The customer I/O device 114 includes hardware and associated logics configured to enable the customer device 110 to exchange information with a customer (e.g., via a touch display, microphone, camera) and other devices. The customer I/O device 114 may include systems, components, devices, and apparatuses that serve both input and output functions, configured to exchange information with external systems (e.g., merchant point of sale devices, computing devices associated with other individuals). Such systems, components, devices and apparatuses include, for example, radio frequency transceivers (e.g., RF or NFC-based transceivers) and other short range wireless transceivers (e.g., Bluetooth®, laser-based data transmitters, etc.).

The financial institution client application 116 is structured to enable the customer to establish and manage financial accounts. Accordingly, the financial institution client application 116 is communicably coupled via the customer network interface 112 over the network 130 to the financial institution computing system 120. In some embodiments, the financial institution client application 116 includes a circuit embodied within the customer device 110. For example, the financial institution client application 116 may include program logic stored in a system memory of the customer device 110. In such arrangements, the program logic may configure a processor of the customer device 110 to present the user with various graphical user interfaces based on information regarding customer accounts. In some embodiments, the financial institution client application 116 is at least partly web-based. As will be understood, the level of functionality that resides on the customer device 110 versus the financial institution computing system 120 will vary depending on the implementation.

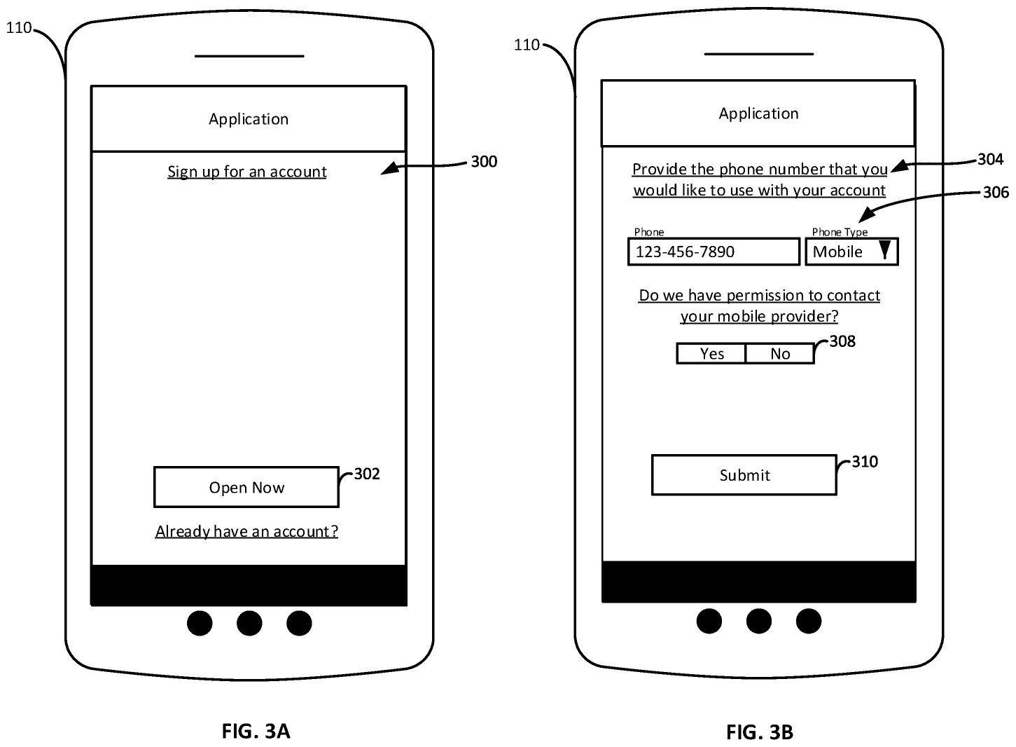

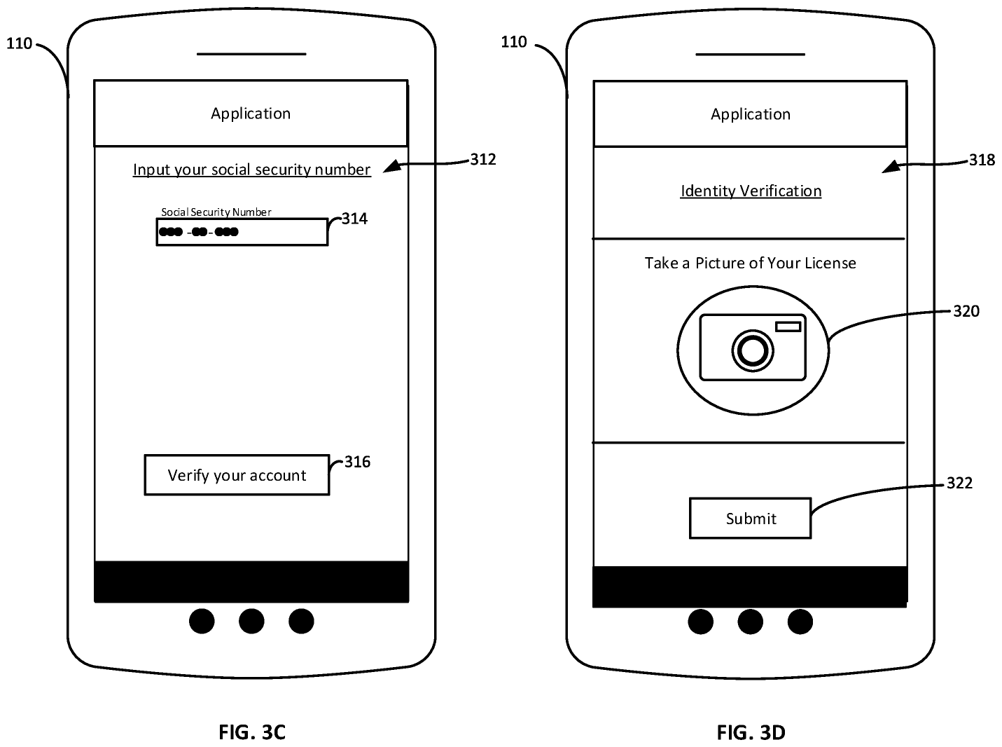

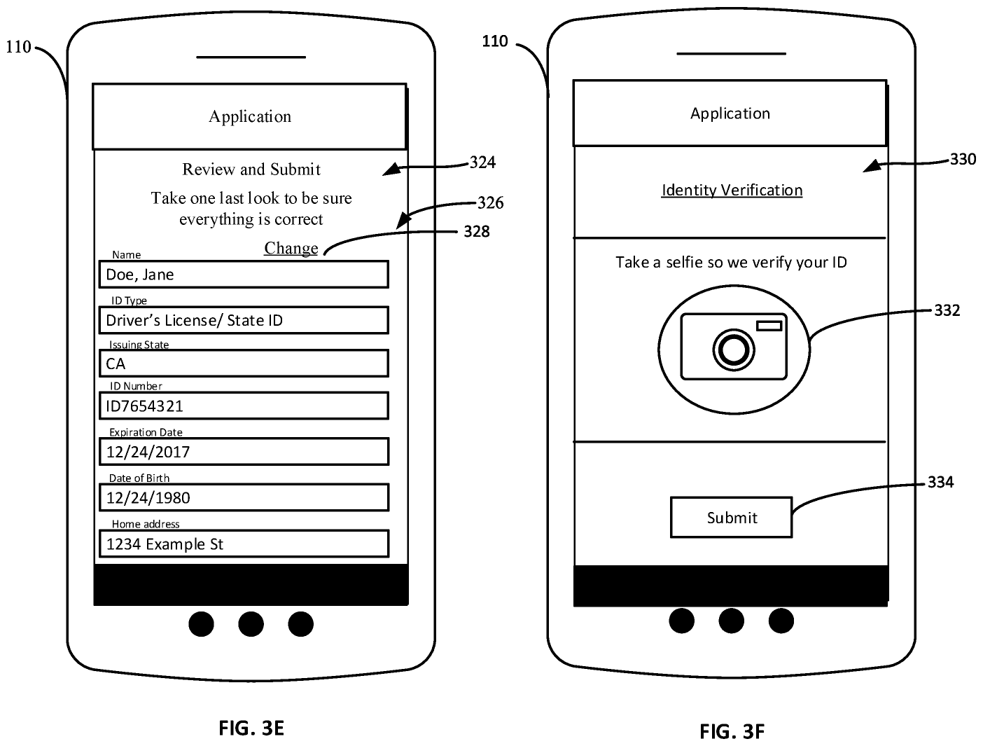

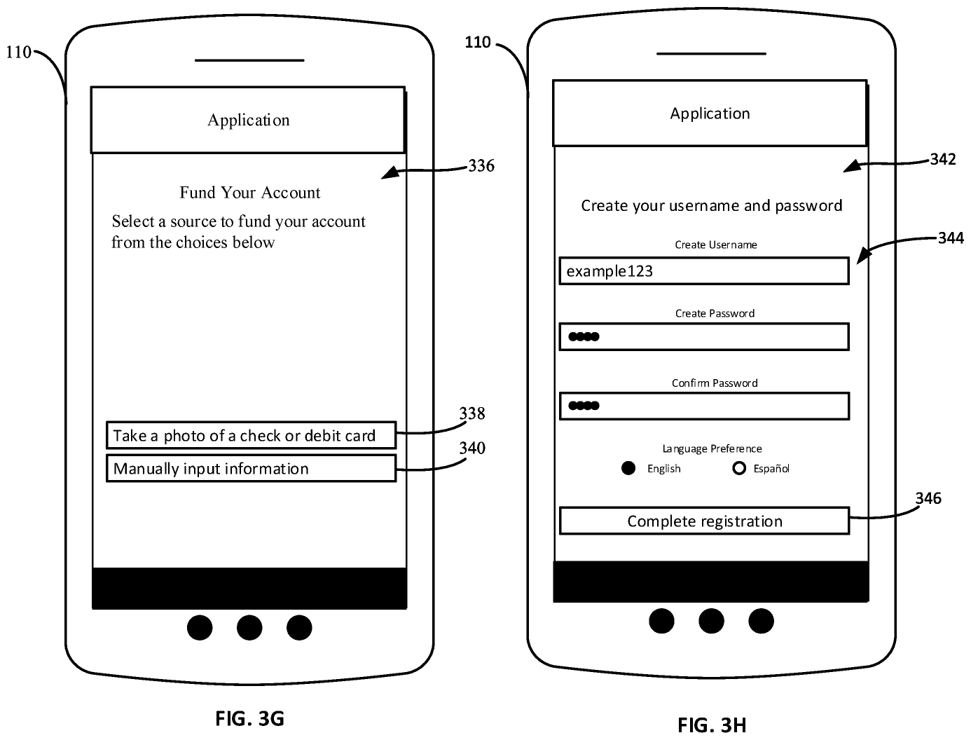

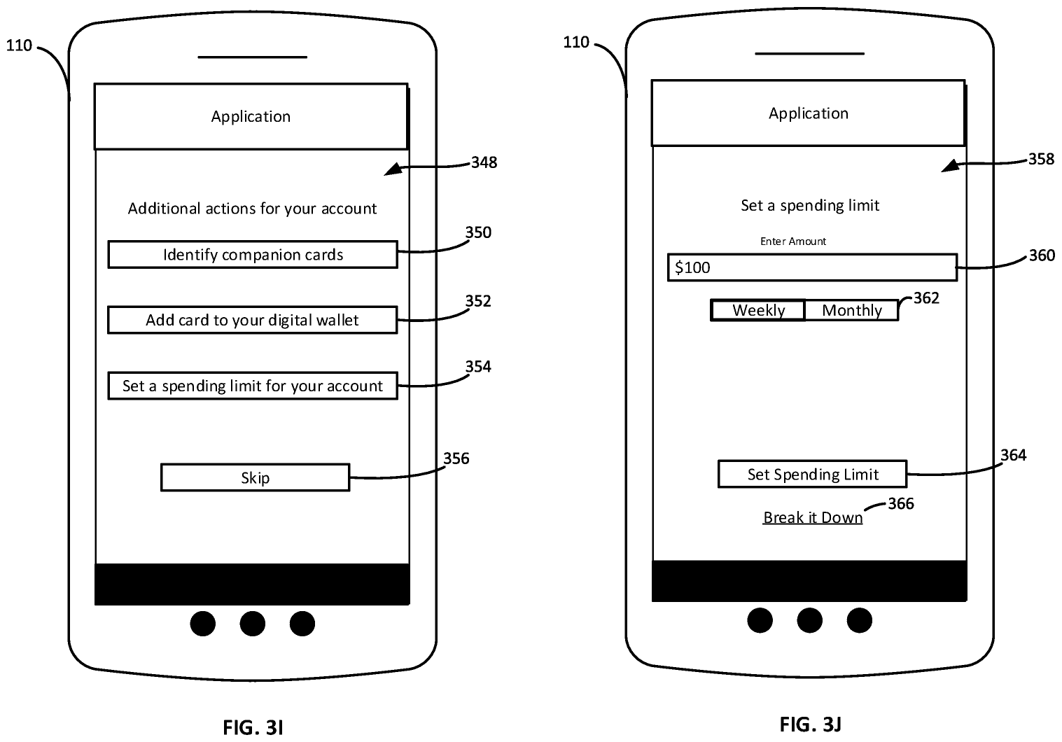

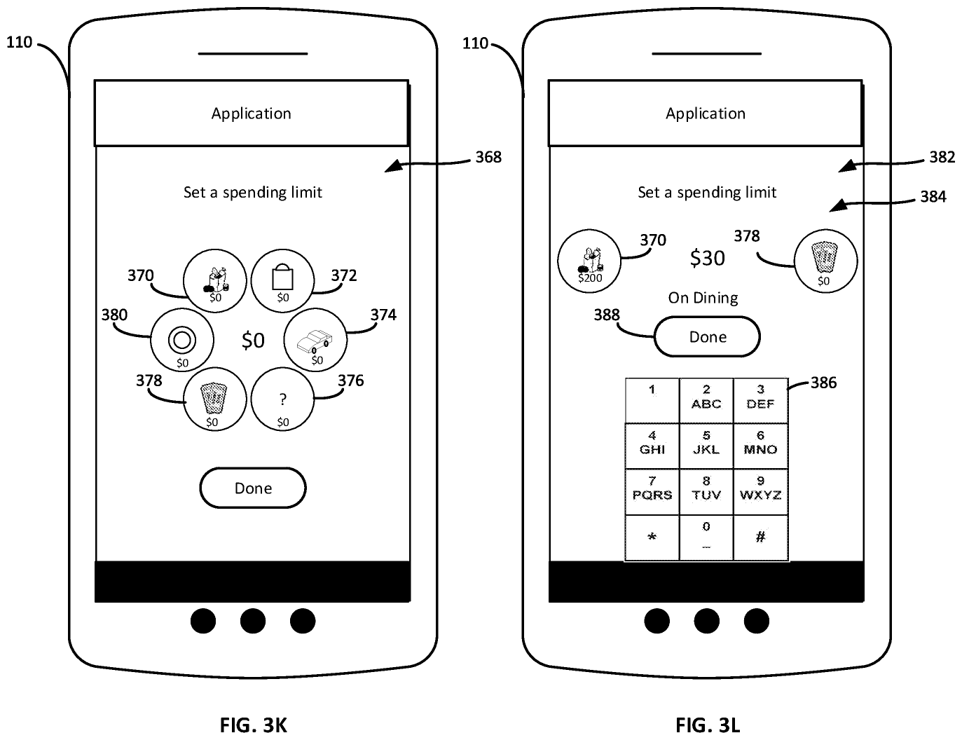

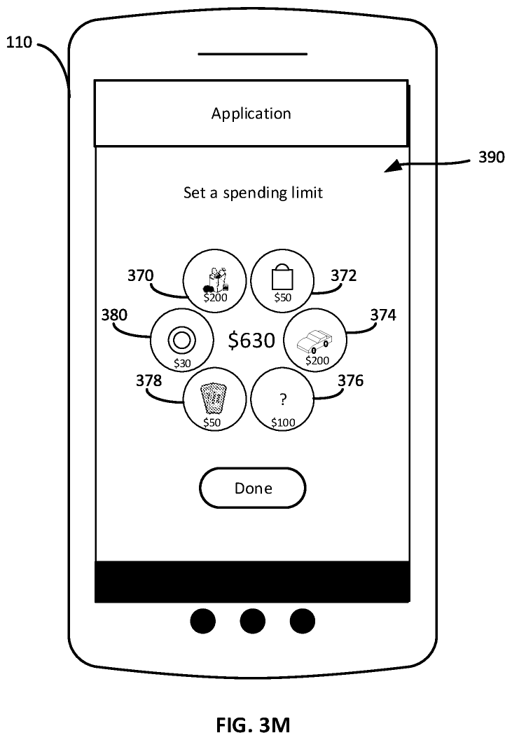

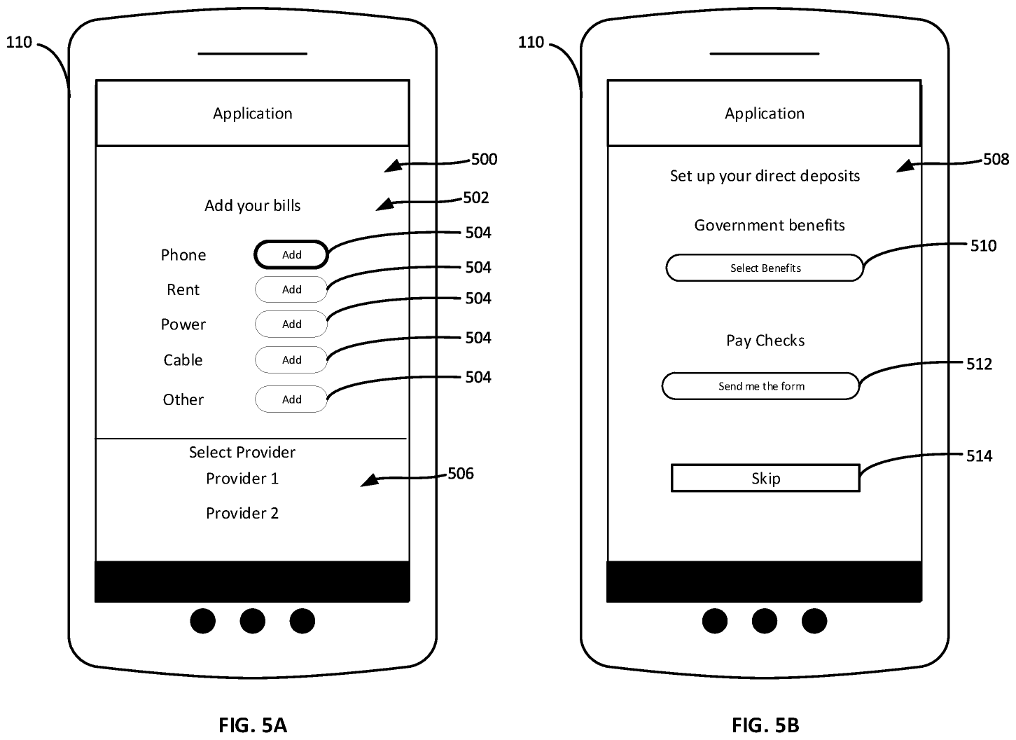

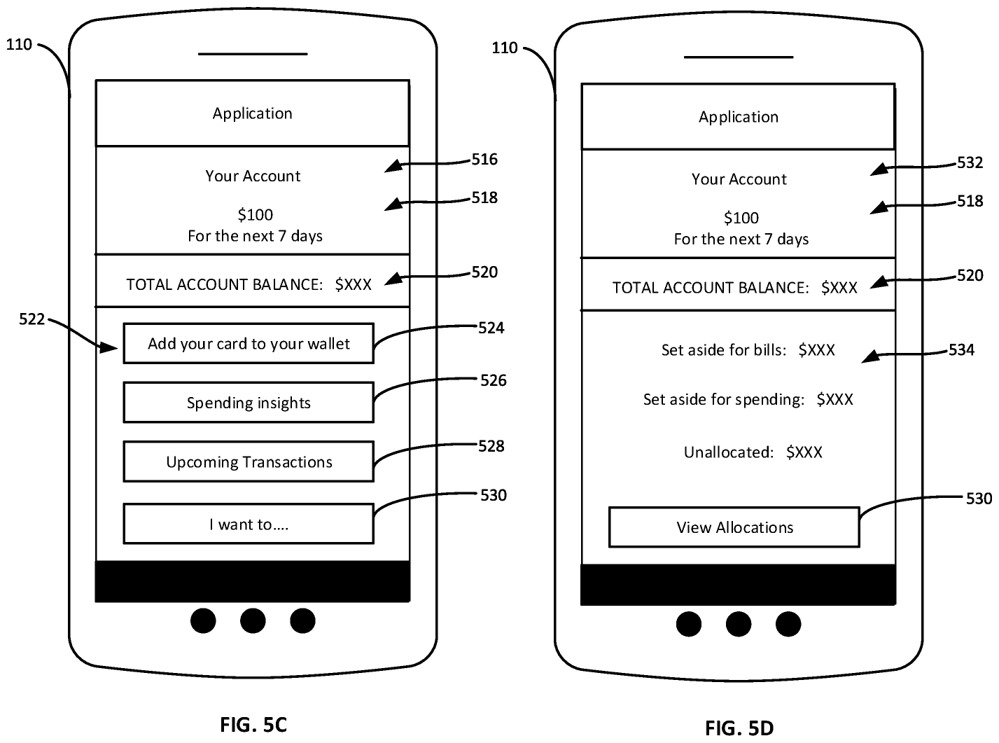

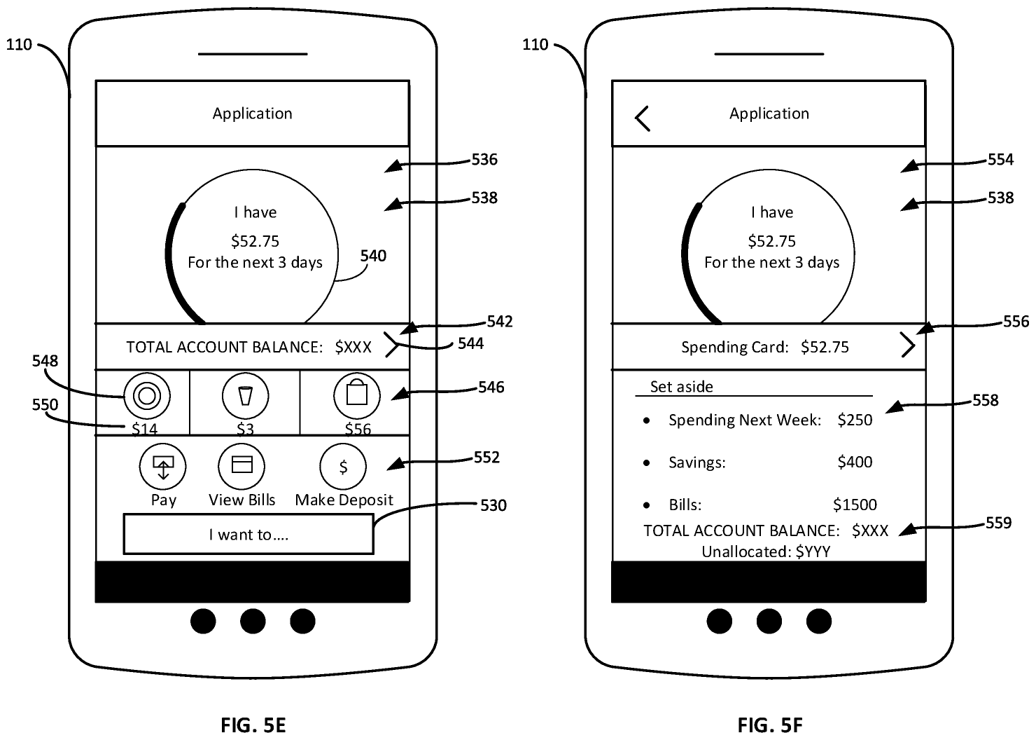

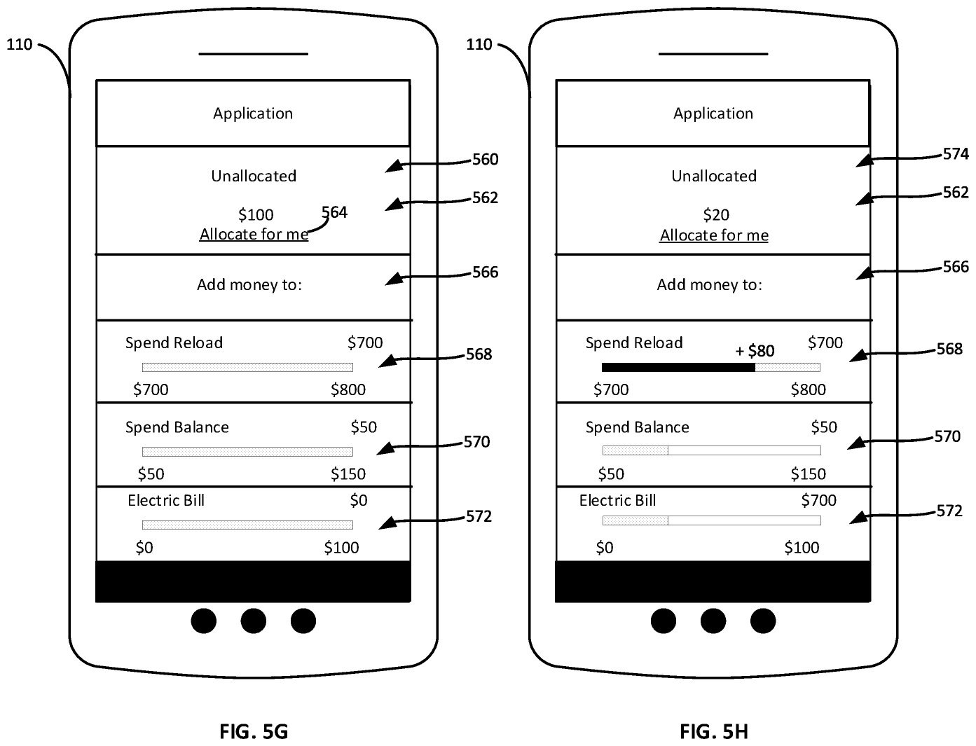

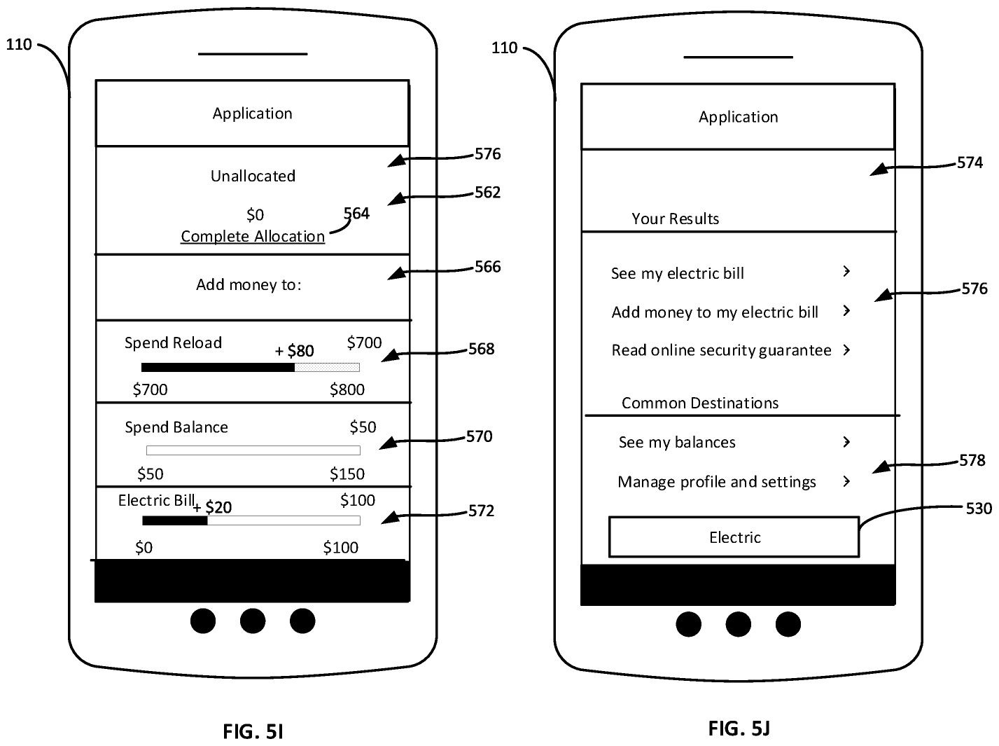

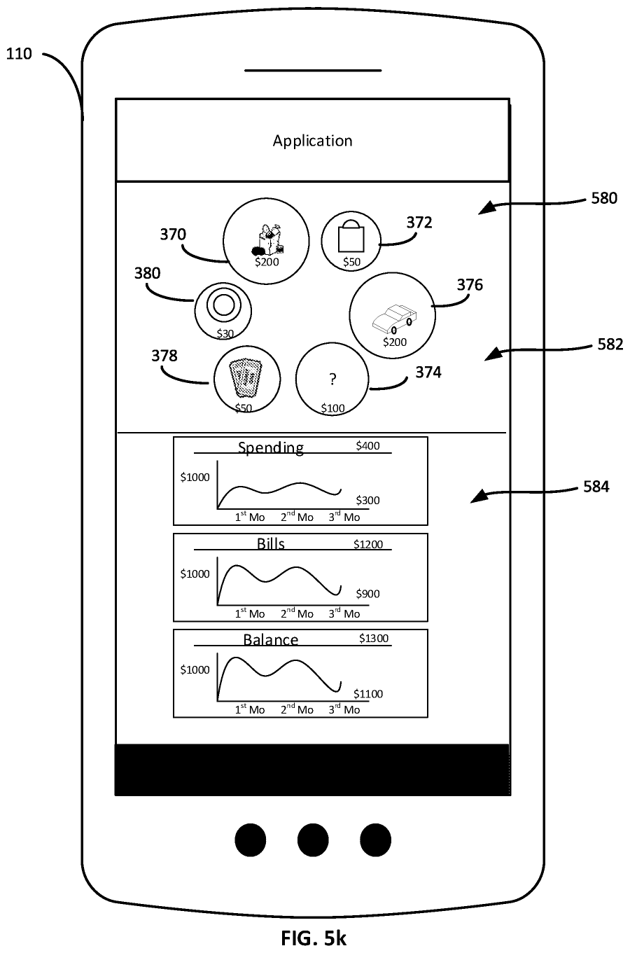

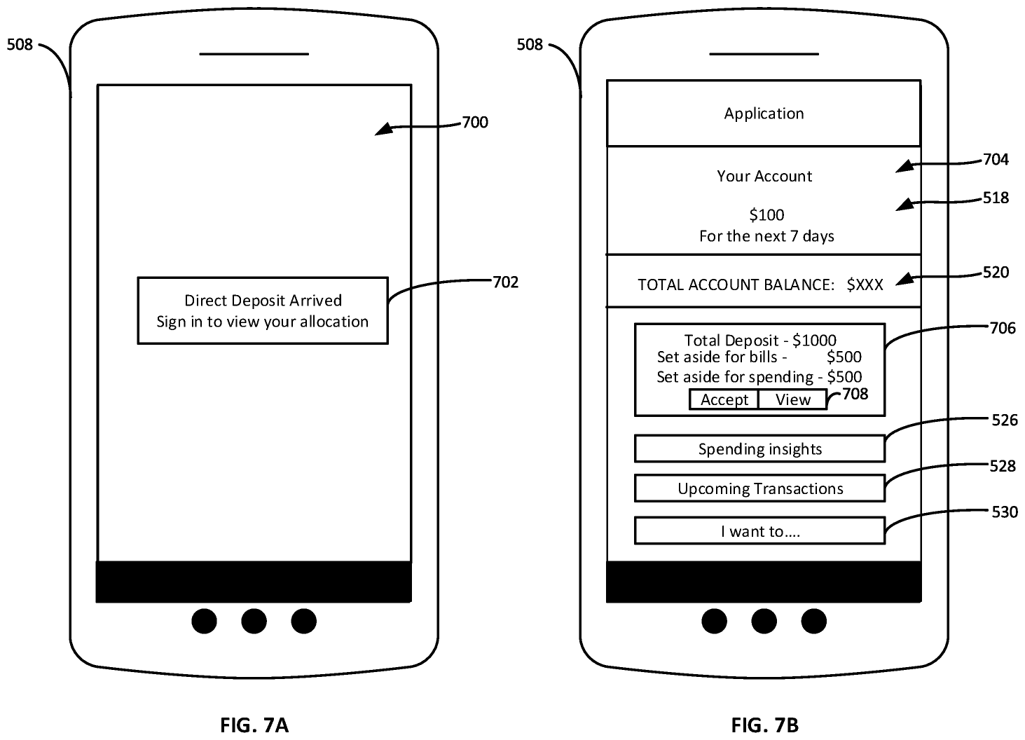

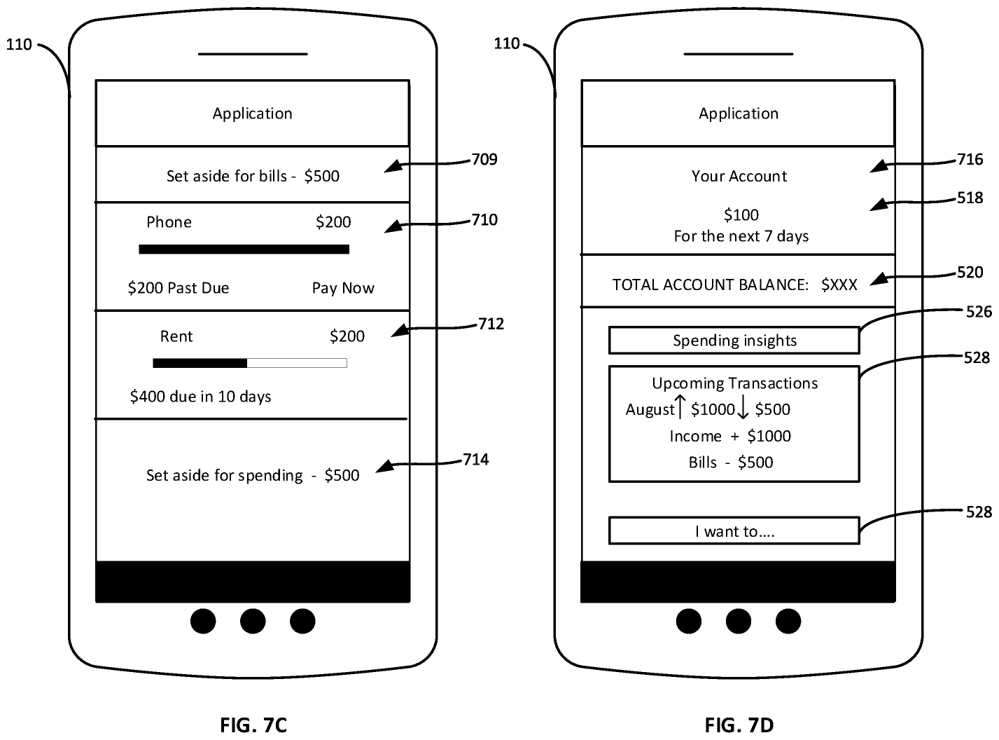

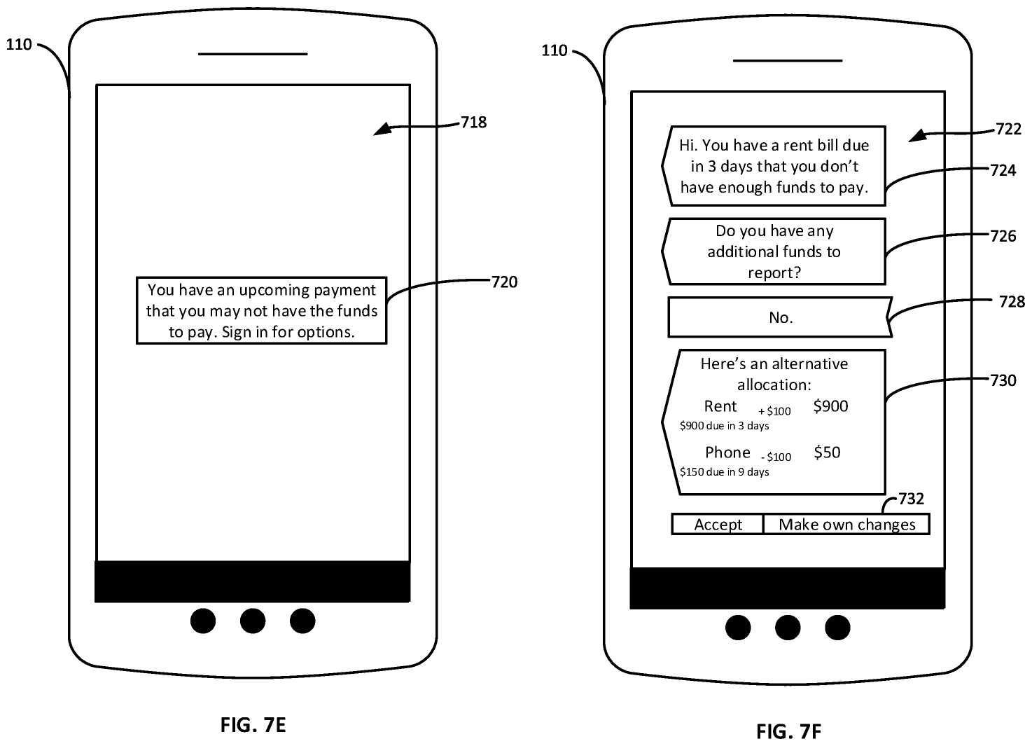

In some embodiments, the displays presented to the customer via the financial institution client application 116 are configured to receive information from the customer to establish an account at the financial institution. Examples of such interfaces are described in more detail with respect to FIGS. 3A-3M. Additionally, the displays also include information pertaining to the status of the customer's accounts. For example, the displays may include account balance information, customer spending limit information, information regarding expenses of the customer (e.g., customer bill payments), and allocations of customer funds between the customer spending account and the customer reserve account. Examples of such interfaces are described below with respect to FIGS. 5A-5K and FIGS. 7A-7F below.

In some embodiments, the financial institution client application 116 includes program logic configured to cause the customer device 110 to process and manipulate customer financial data received from the financial institution computing system 120 over the network 130. For example, in response to funds being deposited into the customer's spending account, the financial institution computing system 120 may transmit updated account balance information to the customer device 110. In response, the customer device 110, via the financial institution client application 116, may manipulate such information using predetermined parameters to determine an allocation of the deposited funds between the customer spending account and the customer reserve account. In some arrangements, the allocation is based on preferences indicated by the customer. In some arrangements, the allocation is a default allocation determined by the financial institution. For example, the customer device 110 may allocate an amount of the deposited funds into the customer spending account that corresponds to a spending limit established by the customer and the remainder of the funds into the customer reserve account.

In some embodiments, the financial institution client application 116 includes an allocation algorithm, process, method, and/or other type of control framework configured to cause the processor of the customer device 110 to allocate customer funds placed into the customer reserve account among various expenses of the customer. For example, the customer device 110 may receive (e.g., from the financial institution computing system 120) information regarding bills (e.g., rent, utility bills, service provider bills) of the customer describing various amounts owed by the customer to recipients by predetermined dates. The allocation algorithm may include a prioritization scheme that designates portions of available funds to each customer bill based on the amount and due date of each payment. Additionally, such an allocation may be used to present the customer with a payment interface configured to present the customer with depictions of upcoming payments owed by the customer and configured to receive inputs from the customer to make such payments in accordance with the allocation.

The financial institution client application 116 may also include monitoring logic configured to track the customer's utilization of accounts and provide recommendations to the customer in response to the detection of certain patterns. For example, such monitoring logic may cause the customer device 110 to compare an amount of customer spending over a predetermined period to a spending limit established by the customer. If the customer's spending level is below the spending limit by more than a first threshold for a predetermined percentage of periods (e.g., weeks, months), for example, the customer may be presented with a suggestion to set aside funds for investment. Alternatively, if the customer's spending level is consistently above the spending limit, the customer may be presented with suggestions on how to reduce spending levels.

In some embodiments, the customer device 110 includes a mobile wallet application (not shown) structured to facilitate and permit payments by interfacing with various accounts held by the customer (e.g., including accounts established via the financial institution client application 116). The mobile wallet financial institution client application is structured to permit the customer to engage in transactions via communication with, for example, a merchant point of sale (“POS”) device via an established communication channel (e.g., near field communications) in accordance with any known standard.

The financial institution computing system 120 is a computing system associated with the financial institution configured to establish and maintain customer accounts. In the example shown, the financial institution computing system 120 includes a network interface 122 configured to communicate data over the network 130, an account management circuit 124, and an accounts database 126. The accounts database 126 is structured to retrievably store information pertaining to accounts held by a number of customers at the financial institution. The accounts database 126 may include non-transient data storage mediums (e.g., local disc or flash-based hard drives, local network servers) or remote data storage facilities (e.g., cloud servers). The accounts database 126 may include personal customer information (e.g., names, addresses, phone numbers), identification information (e.g., driver's license numbers, standard biometric data), and customer financial information (e.g., token information, account numbers, account balances, available credit, credit history, transaction histories).

The account management circuit 124 is configured to create, hold or store, and manage the financial accounts of various customers. In some instances, such management includes maintaining and handling transaction processing for various customer accounts. In some embodiments, the financial institution client application 116 is at least partly provided by the account management circuit 124. In this regard, the account management circuit 124 is configured to communicate information utilized by the customer device 110 to render the various interfaces described herein to the customer. Such information may include, for example, customer account balance information, information regarding customer deposits into the accounts, upcoming payments owed by the customer to various entities, and suggested allocations of customer funds. For example, in some embodiments, the account management circuit 124 performs the operations discussed above and herein with respect to the customer device 110 and/or application 116 to allocate customer funds between the customer spending and reserve accounts and allocate customer funds among payments owed by the customer. In this regard, it should be understood that the activities, operations, and functions described herein with respect to the account management circuit 124 or application 116 may be performed by either the circuit 124 and/or the application 116 in other embodiments. Therefore, describing the activities of these devices is meant to be exemplary only and not limiting.

In various embodiments, the account management circuit 124 is configured to approve the customer for a checking account at the financial institution based on information gathered from the customer via the financial institution client application 116. For example, the account management circuit 124 may communicate with various external computing systems (e.g., credit bureaus, public databases, social media databases) to verify the identity of the customer and determine that the customer is eligible for an account at the financial institution. In response to determining that the customer is eligible, the account management circuit 124 may generate at least two checking accounts (e.g., the customer reserve account and the customer spending account) for the customer.

In this regard, the account management circuit 124 may assign a primary account number and a secondary account number to the customer. For example, the account management circuit 124 may maintain a queue of account numbers that are yet to be assigned to any customers of the financial institution. In response to determining the eligibility of the customer for an account, the account management circuit 124 may designate two such account numbers for the customer. Alternatively, the account management circuit 124 may utilize a random number generator to generate the primary and secondary account numbers for the customer in real time in response to the customer's approval. The primary account number may be associated with the customer reserve account and may be used by the customer to identify an account to which future deposits are to be made. The secondary account number may be associated with the customer spending account. In alternative embodiments, the primary account number (i.e., the account number that the customer uses to deposit funds) may be associated with the customer spending account rather than the customer reserve account. As described herein, the account management circuit 124 may allocate various deposits made by the customer between the customer spending account and the customer reserve account.

In various embodiments, the customer spending account has a payment card (e.g., a debit card, an Automated Teller Machine card) associated therewith. Accordingly, the account management circuit 124 may also generate a card number (e.g., in accordance with the ISO/IEC 7812 standard) for the customer spending account and transmit the card number to a card network computing system to have additional parameters (e.g., the card verification value) associated with the card number. Once all of these parameters associated with the card number have been generated, the account management circuit 124 may initiate a sequence to generate a physical payment card containing such parameters and send the physical payment card to the customer.

In some embodiments, then, the customer's primary account number is associated with the customer reserve account, while the customer's payment card is associated with the customer spending account. Put differently, the account to which the customer deposits funds is separated from a mechanism (the payment card) through which the customer withdraws funds. Such an arrangement beneficially facilitates limiting the customer's spending. Since the customer's deposits are routed to the customer reserve account, portions of the deposits must then be transferred to the customer spending account to render funds available for everyday customer spending. The requirement of such transfers encourages the customer to establish the customer spending limit as, in some embodiments, the customer spending limit is tied to a periodic transfer between the customer reserve account and the customer spending account. Additionally, these transfers create opportunities to notify the customer about other additional aspects of the customer's finances. As described herein, to transfer funds to the customer spending account, the customer must view graphical user interfaces that display information regarding other payment obligations of the customer. As such, the customer is made aware of the context in which additional spending is taking place.

In some embodiments, the account management circuit 124 is configured to digitally activate the payment card in response to receiving a customer preference/input to activate the account. In some embodiments, the customer may provide such an input upon receiving the physical payment card by, for example, calling or otherwise contacting the financial institution. In some embodiments, the customer may provide such an input by indicating a preference to provision the customer spending account to a mobile wallet of the customer.

In some embodiments, the account management circuit 124 is configured to communicate with various external computing systems regarding transfers of funds into and out of the customer's spending and reserve accounts. For example, the customer may provide information (e.g., via a digital form or the like) regarding the customer spending account to an entity (e.g., an employer) from which the customer is to receive a periodic payment. The entity may electronically (e.g., via an Automated Clearing House transaction) transfer funds into the customer spending account via the network 130. Additionally, in various embodiments, the customer may provide information regarding various expenses of the customer. For example, the customer may provide information regarding various accounts (e.g., billing accounts) held by the customer at external entities (e.g., landlords, utilities, other service providers). In response, the account management circuit 124 may formulate requests to have the external entities (e.g., via associated computing systems) provide digital or e-bills to the financial institution computing system 120. Upon a customer payment becoming due or the customer indicating a preference to make a payment, the financial institution computing system 120 may transfer funds from the customer reserve account to an external entity associated with the payment.

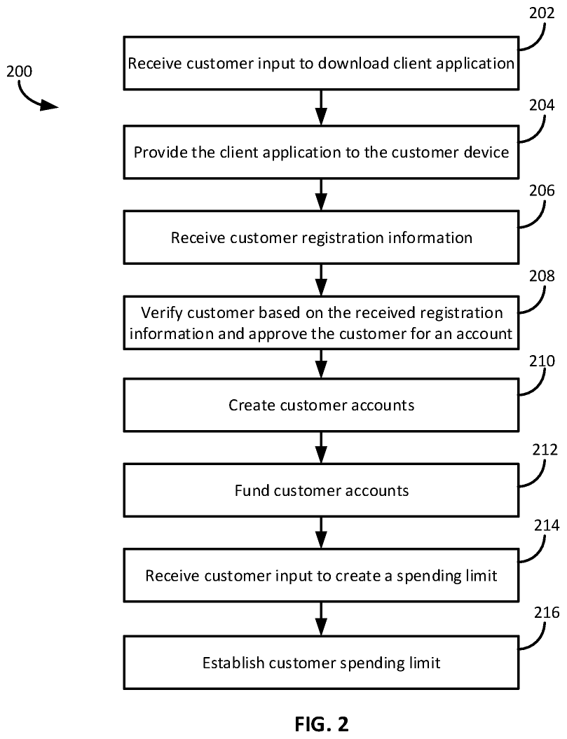

Referring now to FIG. 2, a flow diagram of a method 200 of creating a personalized checking account for a customer is shown, according to an example embodiment. The method 200 may be performed by the components of FIG. 1, such that reference may be made to one or more components of FIG. 1 to aid description of the method 200. In various embodiments, the method 200 may be executed to enable a customer to establish a new account at the financial institution via the customer device 110 and to provide a personal input regarding the new account (e.g., a spending limit). Technically and advantageously, such a process alleviates the need for the customers to physically visit the financial institution, hastens the enrollment process for a new account, and provides an integrated process for a customer to both register for an account and received personalized financial guidance.

At process 202, a customer input to download the financial institution client application 116 is received. For example, in some embodiments, the customer may utilize a web browser on the customer device 110 to access a website provided by the financial institution computing system 120 and provide an input to download the financial institution client application 116. Alternatively or additionally, the customer may provide such an input via an application (e.g., an application store) on the customer device 110.

At process 204, the financial institution client application 116 is transmitted to the customer device 110. For example, in some embodiments, the account management circuit 124 may transmit the financial institution client application 116 to the customer device 110 in response to the customer providing the input received at process 202 from the financial institution website. Alternatively, an external server (e.g., associated with the application store) may transmit the financial institution client application 116 to the customer device 110, register the customer device (e.g., assign a unique identifier to the customer device), and provide the unique identifier and customer identifying information (e.g., a customer name) to the financial institution computing system 120, which may create an entry for the customer in the accounts database 126 (or another database).

In some embodiments, upon the customer initiating the financial institution client application 116 on the customer device 110, the financial institution client application 116 causes the customer device 110 to present the customer with a number of registration interfaces configured to receive information from the customer needed to establish a checking account. Examples of such interfaces are described with respect to FIGS. 3A-3M. Upon the customer entering the requested information, the financial institution client application 116 causes the customer device 110 to transmit the provided information to the financial institution computing system 120 over the network 130. The account management circuit 124 receives the customer provided information at process 206.

At process 208, the account management circuit 124 verifies the customer based on the received registration information and approves the customer for an account at the financial institution. In some embodiments, the account management circuit 124 takes various steps to verify the identity of the customer. For example, if an image of a form of customer identification is received, the account management circuit 124 may verify the authenticity of the form of identification by assessing, analyzing, or otherwise determining the image for various authenticity signatures (e.g., logos, markings, coloring schemes) associated with a legitimate form of customer identification. Additionally, the account management circuit may verify the identity of the customer based on a phone number provided by the customer (e.g., via communications with an external service provider maintaining a database of registered phone numbers). Additionally, the account management circuit 124 may query various external databases (e.g., public databases, databases maintained by credit bureaus) to determine the customer's eligibility for an account. As used herein, the term “eligibility,” when used in relation to determining whether to open an account for a customer, refers to a set of qualifications that must be met in order for the opening of an account to take place. Such qualifications may be established by the financial institution. For example, one such qualification is that the customer is not on any blacklists of known bad actors, as required by the Customer Identification Program. Another may be that the customer does not have a history of fraud, and/or has a credit score that is above a threshold. Any qualification used in determining whether to open an account for a customer is consistent with this term.

At process 210, in response to determining that the customer is eligible for an account, the account management circuit 124 may establish a number of checking accounts for the customer. In an example implementation, the account management circuit establishes two checking accounts for the customer: a customer reserve account and a customer spending account. In such an implementation, the account management circuit 124 may generate (i) a primary account number to be associated with the customer reserve account, (ii) a secondary account number to be associated with the customer spending account, and (iii) a payment card number for the customer. Additionally, the account management circuit 124 may store the generated account numbers in the accounts database 126 in association with the registration information obtained from the customer.

The generation of multiple checking accounts in response to a single account registration input represents a departure from conventional practices. Typically, account opening procedures only enable the customer to establish a single checking account as well as potentially a savings account. Such an account structure places limitations on the types of services that can be provided for the customer. Financial institutions are generally limited in their ability to restrict access to the customer's funds in traditional checking accounts (e.g., as long as the customer maintains a balance above a limited threshold, the customer may withdraw funds from the checking account at will). This makes it difficult for financial institutions to allocate funds in the customer's checking account, as there is little to no reliability in the account balance information. Additionally, the customer's ability to transfer funds from a typical savings account is heavily restricted (e.g., the bank may limit the customer's ability to withdraw funds). As such, any funds placed into the customer's savings accounts are generally unavailable for use in many types of transactions. Put differently, the customer's access to funds is basically binary: either the customer has total access to funds (when in the checking account), or limited access to funds (when in the savings account). Such a difference in accessibility may lead to the customer over-allocating funds to the customer checking account (so as to render more funds immediately available), which may facilitate negative customer spending habits (e.g., over spending and lack of saving).

Technically and beneficially, the systems and methods disclosed herein, by effectively replacing the savings account with an additional checking account, facilitates the financial institution immediately providing an array of financial services to the customer. For example, the customer may generally have unrestricted access to funds placed in the customer spending account. While access to funds placed in the customer reserve account is generally more restricted than in a traditional checking account, such funds may be used for more purposes than those deposited in savings accounts. For example, in various embodiments, funds in the customer reserve account may only be used for transactions meeting certain rules established by the financial institution. To illustrate, the financial institution may maintain a directory of payees (e.g., service providers) to which funds in customer reserve accounts may be transferred. The presence of this particularized account including funds that may be provided to a designated set of payees encourages the customer to set aside funds into the account, thereby ensuring that customer funds are available for the payment of certain customer expenses.

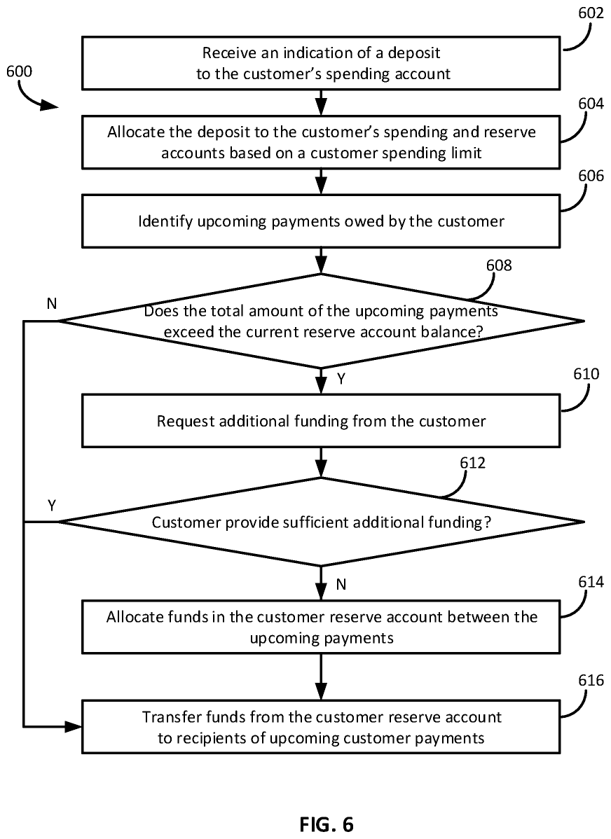

In various embodiments, to utilize the funds placed in the customer reserve account for purposes other than making payments to the designated set of payees, the customer must transfer funds to the customer spending account from the customer reserve account. However, because funds placed in the customer reserve account are allocated amongst various customer payments (e.g., as described with respect to FIG. 6), the requirement of such a transfer creates an opportunity to notify the customer of upcoming payments owed by the customer to the designated set of payees. This encourages the customer to maintain a high enough balance in the customer reserve account in order to timely make such payments, which in turn facilitates a low variability in the balance of the customer reserve account. Such a low variability enables the financial institution to reliably and accurately allocate funds to various customer payment obligations. As such, the multi-checking account structure disclosed herein provides a convenient and effective platform for customer fund management.

At process 212, the account management circuit 124 funds the customer spending account and the customer reserve account. In one embodiment, the registration interfaces described above may request the customer to input information regarding an account to be used by the customer to provide an initial deposit into the customer's new account. Using such information, account management circuit 124 may formulate a transaction request including a deposit amount (e.g., provided by the customer via a registration interface) and the account number provided by the customer and transmit the request to another financial institution via the network 130. The other financial institution may approve the transaction and authorize the financial institution computing system 120 to transfer funds to the customer's new account. Thus, this embodiment describes an electronic money transfer process that is used to fund the customer's account. While this is the preferred embodiment, in another embodiment, a non-electronic transfer may be used. In this implementation, a funding amount of the customer is withdrawn from the customer's existing account. The withdrawn amount may be in the form of a check, cashier's check, cash, and the like. In this instance, the user may have to visit a branch location, upload, or otherwise use these funds to fund the new account. Of course, the financial institution client application 116 may use a check deposit feature (e.g., snap a picture of the check) to alleviate the customer's need to go to the branch location and enable a remote sign-up process.

In some embodiments, as a default, the totality of the initial deposit is placed into the customer spending account. This way, upon the customer activating the payment card associated with the spending account, a substantial amount of the initial deposit (e.g., the amount of the initial deposit less a mandatory minimum balance set by the financial institution) is available for use by the customer. In an alternative embodiment, the totality of the initial deposit is placed into the customer reserve account and all or a portion of the initial deposit is transferred to the customer spending account upon receiving an additional input from the customer (e.g., the customer providing a spending limit). This way, the customer is prevented from utilizing the initial deposit until a spending limit is established, thereby encouraging the customer to establish a spending limit and take full advantage of the financial guidance provided via the financial institution client application 116.

At process 214, the account management circuit 124 receives a customer input to create a spending limit. For example, upon approving the customer for an account at process 208, the financial institution computing system 120 may transmit a notification signal, communication, or message to the customer device 110 (e.g., a text message, an email, a notification generated and provided via the financial institution client application, etc.) which, in response, may present account management interfaces to the customer. The account management interfaces may enable the customer to establish a spending limit with respect to the customer's new account. Upon the customer indicating a preferred spending limit over a predetermined period, the account management circuit 124 establishes the spending limit at process 216 by storing the provided limit in association with the customer's account. As described herein, the spending limit may be utilized in determining amounts to be allocated to the customer spending account and the customer reserve account, and to provide recommendations to the customer.

In various embodiments, funds placed in the customer reserve account are generally set aside for a subset of payments (e.g., bills) owed by the customer and/or other financial goals of the customer such as savings funds. As such, payments made by the customer in relation to other transactions (e.g., at a brick-and-mortar or an online merchant) are generally deducted from the customer spending account. Given this difference in the intended use of funds placed in either account, the customer's access to funds placed in the customer reserve account is generally more restricted than the customer's access to funds placed in the customer spending account. For example, in one embodiment, funds placed in the customer reserve account are unavailable for general use unless the balance of the customer spending account is below a predetermined amount (e.g., the amount of a transaction requested received by the financial institution computing system 120). In another embodiment, funds in the customer reserve account are unavailable for use in general transactions unless the customer authorizes a transfer between the customer spending account and the customer reserve account.

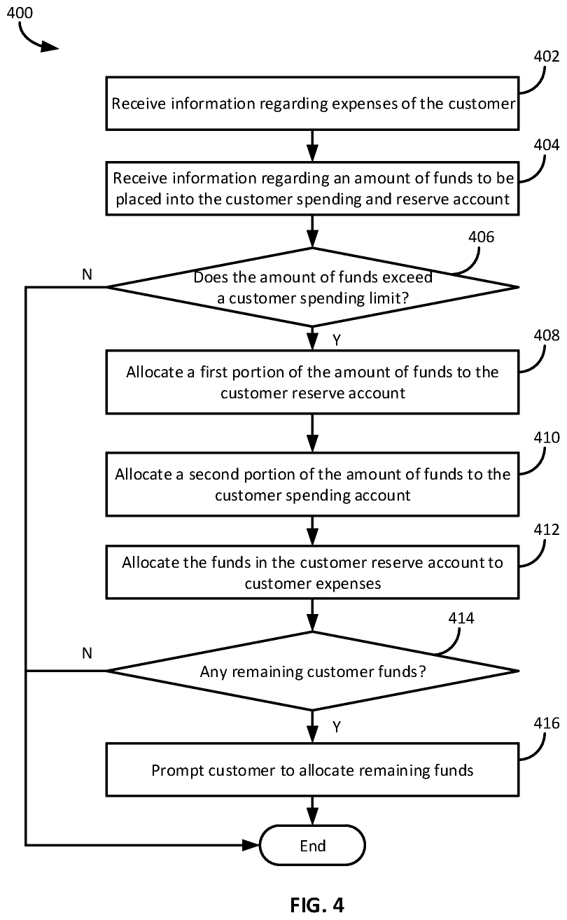

Given this difference in availability of customer funds placed in customer spending and reserve accounts, the initial allocation of funds between the spending and reserve accounts determines the immediate availability of the funds. As described herein, this initial allocation may be done in a number of different ways. For example, in one embodiment, the customer may select an option wherein any available customer funds exceeding the customer spending limit are placed into the customer reserve account to facilitate the customer spending below the spending limit. In another embodiment, the customer may select another option that allocates any available customer funds exceeding a total amount of upcoming payments owed by the customer (e.g., received via the method 400 described in relation to FIG. 4) to the customer spending account to maximize the amount of funds available for general use.

In some embodiments, the account management circuit 124 utilizes the customer spending limit to establish a transaction rule or rule set for the customer's spending account. In some embodiments, the account management circuit 124 utilizes the transaction rule set in the process of approving customer transactions using the customer spending account. For example, in response to receiving a request to deduct funds from the customer spending account (e.g., from a merchant computing system over the network 130), the account management circuit 124 may add an amount in the request to an amount spent by the customer within a predetermined period (e.g., a week). In some embodiments, if the summation of the amounts is above the spending limit, the account management circuit 124 denies the transaction request. In some embodiments, if the summation of the amounts exceeds the spending limit, the account management circuit 124 transmits a notification to the customer device 110 and requests approval from the customer prior to allowing the merchant to deduct the funds.

In some embodiments, the account management interfaces identify other cards that the customer wishes to associate with the new account (hereafter referred to as “companion cards”). For example, the customer may input information regarding a card associated with another customer or another account at the financial institution that the customer wishes to use in concert with the payment card associated with the new account. In response to receiving such information, the account management circuit 124 may determine if the provided account information pertains to an account belonging to another customer. If the customer identifies an account owned or partly owned by another customer, the account management circuit 124 may seek permission from the other customer (e.g., by sending a message via a mobile banking application or e-mail). Upon the other customer providing permission, the account management circuit 124 may crosslink the customer's new account (e.g., the customer spending account) with the account of the other customer.

Through such crosslinking of accounts, financial advising tools (e.g., such as spending alerts) established by the customer with respect to the new account also apply to the crosslinked account. In an example, if, via the methods described herein, the customer establishes a $100 spending limit for the new customer account and identifies another companion card, the spending limit applies to the amount spent using both the customer's new account as well as the companion card. As such, the systems and methods disclosed herein enable related customers to manage combined spending even if one of the accounts was not created via the financial institution client application 116.

Additionally, the account management interfaces may also enable the customer to provide an input to provision the payment card associated with the customer's new account to a digital or mobile wallet. For example, the financial institution client application 116 may include a deep linking feature configured to activate a mobile wallet financial institution client application (e.g., a mobile wallet financial institution client application provided by the financial institution associated with the financial institution computing system 120, or other external mobile wallet providers such as Apple Pay®, Android Pay®, and/or Samsung Pay®) on the customer device 110 in response to the customer indicating a preference to provision the payment card to the mobile wallet. From within the mobile wallet application the customer may provide information relating to the payment card associated with the customer's new account, thereby causing the mobile wallet provider to tokenize the payment card and provision the payment card to the customer's mobile wallet. Beneficially, this linking enables the customer to engage in transactions using the payment card via the customer device 110. Example account management interfaces are described with respect to FIGS. 3I-3J.

Referring now to FIGS. 3A-3J, a number of graphical user interfaces presented to the customer via the financial institution client application 116 are shown, according to an example embodiment. FIGS. 3A-3H show a plurality of graphical user interfaces configured to receive registration information from the customer. FIG. 3A shows an account opening graphical user interface 300 configured to receive a customer input to establish an account at the financial institution associated with the financial institution computing system 120, according to an example embodiment. The account opening graphical user interface 300 includes an account opening button 302 configured to receive a customer input to open an account and initiate a registration sequence for the account.

FIG. 3B shows an information gathering graphical user interface 304, according to an example embodiment. The information gathering graphical user interface 304 includes a mobile device data field 306 configured to receive a phone number of a mobile device, a permission field 308, and a submission button 310. The permission field 308 is configured to receive permission to contact a network service provider to provide the customer with access to a network via the mobile device. In various embodiments, upon the customer entering a mobile number, providing permission, and hitting the submission button 310, the phone number is transmitted to the financial institution computing system 120, which may utilize such information to verify the identity of the customer. For example, the account management circuit 124 may formulate a request via an application programming interface to request information regarding the provided phone number from an external computing system (e.g., a mobile provider). Using information returned by the external computing system, the account management circuit 124 may verify the identity of the customer (e.g., by comparing a name returned by the external computing system to a name provided by the customer).

FIG. 3C shows another information gathering graphical user interface 312 according to an example embodiment. The information gathering graphical user interface 312 includes a social security number field 314 configured to receive a social security number input from the customer and a verification button 316. In some embodiments, upon the customer providing a social security number and selecting the verification button 316, the provided social security number is transmitted to the financial institution computing system 120 and used by the account management circuit 124 to determine the customer's eligibility for an account. For example, the account management circuit 124 may utilize the social security number to request a credit report regarding the customer and assess the information in the credit report against predetermined parameters to determine the customer's eligibility for an account.

FIG. 3D shows an additional information gathering graphical user interface 318 according to an example embodiment. The information gathering graphical user interface 318 includes a photo capture button 320 and a submission button 322. The photo capture button 320 is configured to receive an input to capture a photo of a piece of customer identification such as a driver's license or passport. In response to the customer providing such an input (e.g., by pressing the photo capture button 320), the financial institution client application 116 causes a processor of the customer device 110 to activate a camera on the customer device 110. Additionally, the customer is presented with an interface that shows the view of the camera and includes additional instructions for capturing the image (e.g., the interface may include an outline shape of a piece of identification and prompt the customer to line the piece of identification up within the outline prior to capturing an image). When the customer lines the piece of identification up within the viewing angle of the camera, the camera automatically captures an image of the customer identification. The customer device 110 then transmits (e.g., in response to the customer selecting the submission button 322) the captured image over the network 130 to the financial institution computing system 120. In some embodiments, multiple images of the customer's identification are requested (e.g., of both the front and the back of the customer's identification). In some embodiments, a video of the customer identification is captured.

FIG. 3E shows an example information verification graphical user interface 324. In the example shown, the information verification graphical user interface 324 includes a customer information window 326 and an amendment button 328. The customer information window 326 contains various fields for various items of information gathered from the customer. The amendment button 328 enables the customer to amend the information to be used to create the new account. For example, a customer's preferred address may vary from the address extracted from the captured image of the customer's identification, and the customer may amend the address to a more preferred address. In some embodiments, the financial institution computing system 120 utilizes updated information entered by the customer after pressing the amendment button 328 to verify the identity of the customer and approve the customer for a new account.

FIG. 3F shows an example verification image graphical user interface 330. The verification image graphical user interface 330 instructs the customer to capture an image of the face of the customer via a photo capture button 332 (e.g., similar to the photo capture button 320 discussed with respect to FIG. 3D) and a submission button 334. In various embodiments, the verification image graphical user interface 330 instructs the customer to capture an image, sequence of images, or video of the customer performing a predetermined action (e.g., of the customer blinking, of the customer performing a predetermined pose or gesture) to verify that the verification image was captured in real-time. Upon the customer capturing an image or video and selecting the submission button 334, the financial institution client application 116 may cause the customer device 110 to transmit the captured image to the financial institution computing system 120 over the network 130. Upon receipt of the verification image, the account management circuit 124 may compare the verification image to a portion of the image of the piece of identification containing the customer's face to verify the identity of the customer.

FIG. 3G shows an example account funding graphical user interface 336. The account funding graphical user interface 336 is configured to receive information regarding a payment account that the customer intends to use to fund the new account at the financial institution. In this regard, the account funding graphical user interface 336 includes a photo capture button 338 configured to receive a user reference to capture a photo of a check or a payment card and a manual input button 340 configured to receive a customer preference of the customer to manually enter information (e.g., an account number) associated with an account used to fund the customer's new account. The account management circuit 124 may utilize such information to transfer funds to the customer spending account and the customer reserve account. Of course, in other embodiments, the relevant existing account information may be entered manually and without the use of photo-capture and analysis processes.

FIG. 3H shows an example account access credential graphical user interface 342. In the example shown, account access credential graphical user interface 342 includes a credential window 344 and an enrollment button 346. The credential window 344 includes various fields for enabling the customer to establish login credentials to access the new account. The enrollment button 346 enables the customer-input credentials to be transmitted to the financial institution computing system 120 over the network 130 and stored in the accounts database 126 in association with the newly-created customer account.

Referring now to FIG. 3I, an example account action graphical user interface 348 is shown. In various embodiments, the account action graphical user interface 348 is presented to the customer upon the customer device 110 receiving an indication that the customer has been approved for an account at the financial institution. Alternatively, the account action graphical user interface 348 may be presented to the user immediately after the customer registers for a new account. In the example shown, the account action graphical user interface 348 includes a companion card button 350, a digital wallet provisioning button 352, and a spending limit button 354. The companion card button 350 is configured to receive a customer preference to identify companion cards that the customer wishes to associate with their new account. The digital wallet provisioning button 352 is configured to receive a customer preference to provision the account established via the method 200 to a digital wallet of the customer. In some embodiments, the financial institution client application 116 includes a mobile wallet widget enabling the customer to engage in transactions using the financial institution client application 116. In such embodiments, a customer selection of the digital wallet provisioning button 352 causes the financial institution computing system 120 to tokenize the card number associated with the customer spending account and render the account available for use within the financial institution client application 116.

In some embodiments, the digital wallet provisioning button 352 enables the customer to provision the customer spending account to mobile wallets provided by external computing systems. In this regard, in response to the customer selecting the digital wallet provisioning button 352, the account management circuit 124 communicates the card number associated with the customer spending account to such external computing systems, which tokenizes the card number to render the card number usable within other mobile wallet applications on the customer device 110. The spending limit button 354 is configured to receive a customer preference to establish a spending limit. The account action interface 348 also includes a skipping button 356 configured to receive a customer input to not perform any of the additional actions.

FIG. 3J shows an example spending limit graphical user interface 358. In various embodiments, the customer may be presented with the spending limit graphical user interface 358 upon selecting the spending limit button 354 discussed with respect to FIG. 3I. In the example shown, the spending limit graphical user interface 358 includes an amount entry field 360, a limit preference indicator 362, and a spending limit establishment button 364. The amount entry field 360 is configured to receive a customer-provided spending limit amount. The limit preference indicator 362 is configured to receive a customer preference as to the period of the spending limit. For example, if the customer enters $100 into the amount entry field 360 and presses a weekly portion of the limit preference indicator 362, the account management circuit 124 establishes a weekly $100 spending limit for the customer. In some embodiments, the spending limit graphical user interface 358 includes a breakdown button 366 configured to receive a customer preference to set categorized spending limits.

Referring now to FIG. 3K, a categorized spending limit graphical user interface 368 is shown, according to an example embodiment. The categorized spending limit graphical user interface 368 may be presented to the customer upon the customer selecting the breakdown button 366 on the spending limit graphical user interface 358 described with respect to FIG. 3J. As shown, the categorized spending limit graphical user interface 368 includes icons 370, 372, 374, 376, 378, and 380. Each of the icons 370, 372, 374, 376, 378, and 380 depicts a category of potential customer spending. In the example shown, the icon 370 depicts spending on groceries, the icon 372 depicts other customer shopping expenses (e.g., clothing and other merchandise), the icon 374 depicts automobile-related expenses (e.g., gasoline, repairs), the icon 376 depicts other customer expenses, the icon 378 depicts customer entertainment expenses, and the icon 380 depicts customer dining expenses. Each of the icons 370, 372, 374, 376, 378, and 380 is selectable by the customer to enable the customer to indicate a periodic (e.g., weekly) amount spent by the customer within the depicted category.

Referring now to FIG. 3L, a categorized spending limit graphical user interface 382 is shown, according to an example embodiment. The categorized spending limit graphical user interface 382 may be presented to the customer upon the customer selecting any of the icons 370, 372, 374, 376, 378, and 380 of the categorized spending limit graphical user interface 368 described with respect to FIG. 3K. As shown, the categorized spending graphical user interface 384 includes a category selection window 384, a numerical entry keyboard 386, and an entry button 388. The category selection window 384 enables the customer to select a category from the categories depicted by the icons 370, 372, 374, 376, 378, and 380 and to input a periodic limit for each category via the numerical entry keyboard 386 and entry button 388. As shown, the category selection window 384 includes a subset of the icons 370, 372, 374, 376, 378, and 380. The customer selects a particular category by positioning a corresponding icon in the center of the category selection window 384. Upon the customer selecting a particular icon, the icon is replaced with an amount input window enabling the user to enter a spending limit for that particular category. The user may scroll through the category selection window 384 to select any of the icons 370, 372, 374, 376, 378, and 380.

Referring now to FIG. 3M, a finalized spending limit graphical user interface 390 is shown, according to an example embodiment. In one embodiment, the finalized spending limit graphical user interface 390 is presented to the customer upon the customer completing the process of inputting a spending limit for each of the categories depicted by the icons 370, 372, 374, 376, 378, and 380 via the process described with respect to FIG. 3L. As shown, each of the icons 370, 372, 374, 376, 378, and 380 has been updated to include the amounts input by the customer. Additionally, a total spending limit, which is a summation of the spending limits for each of the individual categories, is presented to the customer. In some embodiments, the displayed total spending limit represents a periodic amount that is transferred from the customer spending account and the customer reserve account. For example, each week, an amount corresponding to the total spending limit may be transferred from the customer reserve account into the customer spending account.

Additionally, as described herein, the financial institution computing system 120 or the customer device 110 may track the customer's spending in each of the categories depicted via the icons 370, 372, 374, 376, 378, and 380 to provide insights to the customer as to the customer's level of spending in each category. For example, in some embodiments, the financial institution computing system 120 maintains a directory of merchants that associates a number of different merchants with each of the categories. Upon the customer performing a transaction via the customer spending account, the financial institution computing system 120 accesses the directory and, based on the merchant, categorizes the transaction and updates the customer's transaction history accordingly. This way, the customer may view the transactions conducted in each category.

In some embodiments, the financial institution computing system 120 is configured to deny transaction requests that cause the customer to spend more than a spending limit in a particular category. Alternatively or additionally, in response to receiving such a transaction request, the financial institution computing system 120 may provide a notification to the customer device 110 to seek approval from the customer prior to authorizing such a transaction. This way, not only is the customer potentially prevented from generally spending more than a desired amount, but also prevented from spending more than a desired amount in a particular category.

Referring now to FIG. 4, a flow diagram of a method 400 of allocating customer funds between a customer spending account and a customer reserve account is shown, according to an example embodiment. The method 400 may be performed by the components of FIG. 1 such that reference to the components of FIG. 1 may be made to aid the description of the method 400. In various embodiments, the method 400 may be executed via the account management circuit 124 at the financial institution computing system 120 to allocate customer funds between the customer spending account and the customer reserve account established via the method 200 discussed above.

At process 402, the account management circuit 124 receives information regarding one or more expenses of the customer. In some embodiments such information may be received from the customer device 110. For example, in some embodiments, the financial institution client application 116 causes the customer device 110 to present the customer with a graphical interface configured to receive information regarding the customer's bills or any other expenses, which includes recurring and non-recurring expenses. An example of such a graphical user interface is described with respect to FIG. 5A. Via the graphical user interface, the customer may input amounts typically paid by the customer (e.g., a monthly rent payment). Alternatively or additionally, the customer may input the identity of various entities (e.g., landlords, utility companies, service providers) to which the customer owes a payment and input associated account numbers. Upon the customer providing such information, the financial institution client application 116 may cause the customer device 110 to transmit the information to the financial institution computing system 120 over the network 130.

Using such information, the account management circuit 124 may request information the identified entities. For example, using a customer account number associated with a particular service provider, the account management circuit 124 may request an e-bill from a computing system associated with the service provider. The e-bill may contain information regarding a payment owed by the customer such as an amount and due date. In some embodiments, the account management circuit 124 is configured to extract information regarding a payment owed by the customer from the e-bill and transmit such information to customer device 110 to assist in the rendering of various graphical user interfaces described herein.

At process 404, the account management circuit 124 receives information regarding an amount of funds to be placed into the customer spending account and customer the customer reserve account. In some embodiments such information may be received from the customer device 110. For example, in some embodiments, the financial institution client application 116 causes the customer device 110 to present the customer with a graphical interface configured to receive information regarding a deposit into the customer spending account and the customer reserve account. An example of such a graphical user interface is described with respect to FIG. 5B. For example, via such a graphical user interface, the customer may request a form that may be used by an employer of the customer to automatically deposit the customer's paycheck into the customer spending account and the customer reserve account. Alternatively or additionally, such a graphical user interface may be configured to receive information regarding governmental benefits of the customer, which may be used by the financial institution computing system 120 to request that an associated governmental entity directly deposit the governmental benefits into the customer's account. In some embodiments, the customer may deposit funds from an existing bank account of the customer into the customer spending account and the customer reserve account.

At process 406, the account management circuit 124 determines if the amount of funds to be deposited in the account is greater than a customer spending limit (e.g., established via the method 200 described with respect to FIG. 2. In some embodiments, amounts corresponding to the customer's spending limit are automatically allocated to the customer spending account. Accordingly, if the amount to be deposited by the customer does not exceed the customer's spending limit, the account management circuit 124 may allocate deposits completely into the customer spending account and the method 400 ends.

At processes 408 and 410, if the customer has deposited more than the spending limit, the account management circuit 124 is configured to allocate a first portion of the amount of funds to the customer reserve account based on the expense information and allocate a second portion of the amount of funds to the customer spending account. In some embodiments, the account management circuit 124 is configured to initially allocate an amount corresponding to the customer spending limit into the customer spending account. The account management circuit 124 then compares the amount of the remaining funds to a combined amount of expenses owed by the customer within a predetermined period (e.g., a week, a month). If there are sufficient remaining funds to timely pay the customer's expenses, the account management circuit 124 may deposit an amount corresponding to the customer expenses into the customer payments. As the expenses become due, the account management circuit 124 may transfer funds from the customer reserve account to accounts of entities to which the customer owes payment.

In some embodiments, if there are insufficient remaining funds to timely pay the customer expenses, the account management circuit 124 may transmit an allocation suggestion to the customer device 110. The allocation suggestion may, for example, suggest that the customer reallocate funds from the customer spending account to the customer reserve account to provide the customer reserve account with sufficient funds to timely pay the customer expenses.

At process 412, the account management circuit 124 allocates the funds placed in the customer reserve account to the customer expenses. In an example, if there are sufficient funds available to timely pay all of the customer expenses, the account management circuit 124 divides the funds placed into the customer reserve account between each expense in accordance with the amount of each expense. However, if there are insufficient funds available to timely pay all of the customer expenses, the account management circuit 124 may generate an allocation between the customer expenses. In various embodiments, the account management circuit 124 generates an allocation using a prioritization algorithm that prioritizes the customer expenses based on a due date and amount. Generally speaking, customer expenses having greater amounts and having sooner due dates will receive a greater allocation.

In some embodiments, the account management circuit 124 allocates the available customer funds based on the entities to which the customer owes payments. For example, the financial institution computing system 120 may maintain a database storing information regarding the payment policies of various entities. The payment policies may include information pertaining to fees for late payments. In such an embodiment, the account management circuit 124 may retrieve payment policy information relating to the entities identified by the customer and allocate the available customer funds based on projected late fee amounts.

In various embodiments, once the account management circuit 124 generates an allocation, the allocation may be transmitted to the customer device 110 over the network 130 to render an allocation graphical user interface to the customer. The allocation graphical user interface may include representations of the amounts allocated to the customer spending account and the customer reserve account. The allocation graphical user interface may also include amounts allocated to upcoming payments owed by the customer. An example allocation graphical user interfaces are described with respect to FIG. 5D.

At process 414, the account management circuit 124 determines if the customer has any remaining funds. For example if the total available amount of funds (e.g., the combination of an initial account balance and a deposit of customer funds into the customer spending account and the customer reserve account) exceeds the total amount of customer expenses by more than the customer spending limit, the account management circuit 124 may determine that there are remaining customer funds.

At process 416, the account management circuit 124 prompts the customer to allocate any remaining funds. In some embodiments, the account management circuit 124 may initially allocate any remaining customer funds to the customer spending account, but indicate to the customer that such remaining funds are unallocated. This way, the remaining funds are available for utilization by the customer in payment card transactions. Alternatively, the account management circuit 124 may initially allocate any remaining customer funds to the customer reserve account, but indicate to the customer that such remaining funds are unallocated. Alternatively, the account management circuit 124 may initially allocate a first portion (e.g., a first half) of the remaining funds to the customer spending account and a second portion of the remaining funds to the customer reserve account (e.g., a second half). This way, the customer has a portion of the remaining funds for payment card transactions, and a portion set aside for future expenses of the customer that may become due.

In some embodiments, the account management circuit 124 facilitates the transmittal of an allocation notification to the customer device 110. The allocation notification may include a push notification (e.g., transmitted via a push notification service) alerting the customer of an unallocated amount, and prompt the customer to sign into the financial institution client application 116 to provide an input to allocate the remaining amount.

Referring now to FIG. 5A, an example expense graphical user interface 500 is shown. In some embodiments, the expense graphical user interface 500 may be presented to the customer via the financial institution client application 116 as an extension of the registration process described with respect to FIGS. 3A-3J. For example, upon the customer registering for an account, funding the account and setting up account access credentials, the financial institution client application 116 may cause the customer device 110 to present the customer with the expense graphical user interface 500. In some embodiments, the customer may provide an input to view the expense graphical user interface 500.

As shown, the expense graphical user interface 500 includes a payment addition window 502 and an entity identifying window 506. The payment addition window 502 includes a plurality of classifications of various entities to which the customer may owe payments. Next to each classification is an addition button 504. As indicated by the emboldened addition button 504, upon the customer selecting a particular addition button 504, the customer device 110 may retrieve a listing of entities associated with the selected classification (e.g., from a database maintained at the financial institution computing system 120) and use the retrieved listing to populate the entity identifying window 506. The entity identifying window 506 enables the customer to select an entity from the listing of entities at which the customer has an account.

In some embodiments, upon the customer selecting a particular entity, the customer may be brought to an additional interface enabling the customer to input an account number of the customer at the entity. As described herein, the financial institution computing system 120 may utilize such information to receive information regarding payments owed by the customer from an external computing system and make such payments using funds placed into the customer reserve account. Additionally, the customer may input additional preferences as to making payments to a particular entity. For example, the customer may indicate a preference to have the customer's bills paid automatically.

Referring now to FIG. 5B, an example deposit graphical user interface 508 is shown. In some embodiments, the deposit graphical user interface 508 may be presented to the customer via the financial institution client application 116 as an extension of the registration process described with respect to FIGS. 3A-3J. For example, upon the customer registering for an account, funding the account, and setting up account access credentials, the financial institution client application 116 may cause the customer device 110 to present the customer with the deposit graphical user interface 508. In some embodiments, the customer may provide an input to view the expense graphical user interface 500.

As shown, the deposit graphical user interface 508 includes a government benefit button 510, a direct deposit button 512, and a skipping button 514. The government benefit button 510 is configured to receive a customer preference to deposit government benefits into the customer's account. In response to the customer selecting the government benefit button 510, the customer may be presented with another interface enabling the customer to identify a government benefit (e.g., from a dropdown menu) and input information (e.g., an account number) associated with the benefit. The financial institution computing system 120 may utilize such information to request that the customer's benefits be deposited into the customer spending and reserve account. The direct deposit button 512 is configured to receive a customer preference to have a paycheck or the like deposited into the customer's spending and reserve accounts. In some embodiments, in response to the customer selecting the direct deposit button 512, the financial institution computing system 120 may send the customer or employer of the customer a form (e.g., via e-mail, the financial institution client application 116, or paper-based mail) to establish the customer account's as a direct deposit account. The skipping button 514 is configured to receive a customer preference to skip adding any deposits to the customer's spending and reserve accounts.

Referring now to FIG. 5C, an example account management graphical user interface 516 is shown. In various embodiments, the account management graphical user interface 516 is the home page presented to the customer upon the customer accessing the financial institution client application 116 on the customer device 110. For example, once all of the registration steps described herein have been completed, the account management graphical user interface 516 may serve as an initial starting screen for the customer to access various functions described herein.

As shown, the account management graphical user interface 516 includes a spending limit portion 518, an account balance portion 520, and a navigation portion 522. The spending limit portion 518 includes a representation of the customer spending limit (e.g., established via the method 200 discussed above). For example, the spending limit portion may include an amount remaining and a predetermined period before reaching the spending limit for the predefined period. The amount remaining may be the customer spending limit less the amounts of any transactions engaged in by the customer since the initiation of a spending limit period. The account balance portion 520 includes a representation of the total amount of customer funds in both the customer spending account and customer reserve account. As such, even though the customer has two separate checking accounts, the financial institution client application 116 provides the appearance that the customer has only a single checking account, thus simplifying the process of managing the account for the customer.

The navigation portion 522 provides the customer with access points to various functionalities described herein. As shown, the navigation portion 522 includes a dynamic icon 524, an advising icon 526, a transaction icon 528, and a navigation dialogue box 530. In some embodiments, the dynamic icon 524 updates depending on various actions taken by the customer within the financial institution client application 116. For example, if the customer is yet to provision the payment card associated with the customer spending account to the customer's digital wallet, the dynamic icon 524 may be configured to receive a customer preference to provision the payment card to the digital wallet. For example, the dynamic icon 524 may provide an input to program logic configured to interface with program logic of a mobile wallet application on the customer device 110, which may enable the customer to provision the payment card to the digital wallet. Alternatively or additionally, the dynamic icon 524 may cause the customer device 110 to transmit a provisioning signal to the financial institution computing system 120, which may (e.g., via the account management circuit 124) perform a process to provision the digital payment card to the customer's digital wallet.

In various embodiments, the dynamic icon 524 updates based on the most recent notification received by the customer from the financial institution computing system 120 within a predetermined period. If no notifications are received within the predetermined period, the account management graphical user interface 516 may not include the dynamic icon 524 (or it may be grayed out, or provided with an indicator that alerts the user to the fact that no notifications were received).

The advising icon 526 is configured to receive a customer input to view various recommendations generated by the customer device 110 and/or financial institution computing system 120 in accordance with the systems and methods disclosed herein. As described herein, program logic of the customer device 110 or the financial institution computing system 120 may be configured to assess account balance information and the customer's transaction history to make various recommendations to the customer. Upon the customer selecting the advising icon 526, the customer may be brought to another interface containing such suggestions.

The transaction icon 528 is configured to receive a customer preference to view upcoming payments owed by the customer (e.g., obtained via the customer entered information into an interface such as the expense graphical user interface 500 discussed with respect to FIG. 5A). The navigation dialogue box 530 is configured to provide the customer with access to a plurality of additional functionalities. For example, via the navigation dialogue box 530, the customer may input a sequence of symbols relating to the functionality that the customer wishes to access. In response to the customer inputting a symbol sequence, the customer device 110 may access a lookup table to identify an additional interface to present to the customer based on the symbol sequence provided by the customer. In some embodiments, upon the customer selecting the navigation dialogue box 530, a function history overlay is presented to the customer as an overlay to the account management graphical user interface 516. The function history overlay may include a listing of functionalities utilized by the customer within a predetermined period.

Referring now to FIG. 5D, an example allocation graphical user interface 532 is shown. In various embodiments, the customer may access the allocation graphical user interface 532 by indicating a preference to view allocations within the navigation dialogue box 530 in the account management graphical user interface 516 discussed with respect to FIG. 5C. In the example shown, the allocation graphical user interface 532 includes the spending limit portion 518 and the account balance portion 520, and the navigation dialogue box 530 discussed with respect to FIG. 5C. However, in the allocation graphical user interface 532, the navigation portion 522 is updated to include an allocation portion 534. The allocation portion 534 lists amounts of customer funds having various allocation statuses (e.g., allocated to the customer reserve account, allocated to the customer spending account, and unallocated). In some embodiments, the allocation portion 534 includes a portion configured to receive a customer preference to adjust the allocations (e.g., to transfer funds between the customer reserve account and the customer spending account, or to allocate unallocated funds).

Referring now to FIG. 5E, an example account management graphical user interface 536 is shown. In various embodiments the account management graphical user interface 536 serves as a home screen for the financial institution client application 116. In the example shown, the account management graphical user interface 536 includes a spending limit portion 538, an account balance portion 542, a transaction portion 546, and a navigation portion 552. The spending limit portion 538 contains information regarding the relationship between the customer's spending and the customer's spending limit. As shown, the spending limit portion 538 includes a graphical status indicator 540. A portion of the graphical status indicator 540 is differentiated (e.g., bolded, colored differently) from the remaining portion of the graphical status indicator 540 to indicate a remaining portion of the customer's spending limit. As such, a ratio of the differentiated portion to the entire length of the graphical status indicator 540 may correspond to a percentage of the customer's spending limit that the customer has remaining to spend. In the example shown, the graphical status indicator 540 also surrounds a description the amount remaining that the customer has to spend. Accordingly, upon initiation of the financial institution client application 116, the customer device 110 may retrieve customer transaction data (e.g., either from the internal memory of the customer device 110 or the financial institution computing system 120), determine an amount that the customer has spent within a predetermined period, and compare the amount to the spending limit to render the spending limit portion 538.

In some embodiments, the account balance portion 542 is similar to the account balance portion 520 described with respect to FIG. 5C, except that the account balance portion 542 further includes a balance viewing icon 544 configured to receive a customer input to view the various account balances associated with the customer's account. The transaction portion 546 includes a listing of transactions that the customer has engaged in using the customer spending account. In the example shown, the transaction portion 546 includes a number of transaction entries, with each entry including a graphical icon 548 and an amount 550 associated with a particular transaction. In some embodiments, each of the entries also includes the dates at which the respective transactions took place. In an embodiment, the transaction portion 546 includes an entry for each transaction that the customer has engaged since the customer's spending limit was reset (e.g., if the customer has established a monthly spending limit, the transaction portion 546 may include an entry for each customer transaction since the beginning of the month). In some embodiments, the customer may scroll through the transaction portion 546 (e.g., by pressing a portion of a screen of the customer device 110 and sliding in a direction) to view all of the entries.

In the example shown, the icons 548 in each transaction entry reflect the type of transaction. The icons may be identical to the icons 370, 372, 374, 376, 378, and 380 described with respect to FIG. 3M. For example, in some embodiments, financial institution client application 116 causes the customer device 110 to access a lookup table that associates various merchant names (or merchant category codes) with particular graphical icons. In such embodiments, upon the customer device 110 retrieving customer transaction information (e.g., describing the amounts, timing, and merchants of recent customer transactions) from the financial institution computing system 120, the customer device 110 associates each transaction with an icon based on the merchant of the transaction, and populates various entries of the transaction portion 546 using the amounts and the associated icons. This way, the customer is able to quickly view the types of transactions that they have recently engaged in.

In some embodiments, the entries in the transaction portion 546 show up in a predetermined order. For example, in one embodiment, the transactions show up in chronological order. As such, the customer's most recent transaction may show up in the leftmost entry of the transaction portion 546, and the oldest transaction may show up in the rightmost entry. The customer may scroll to the left to view entries associated with older transactions. In some embodiments, the icons 548 are selectable by the customer to bring the customer to an additional graphical user interface containing information regarding the transaction associated with the icon 548. For example, such a graphical user interface may include the specific merchant and timing of the transaction, as well as any receipts stored in association with the transaction.

The navigation portion 552 includes various icons enabling the customer to take various other actions with respect to the customer spending account and the customer reserve account. For example, the navigation portion 552 may include a payment icon enabling the user to make a payment via the customer's mobile wallet (e.g., via a separate mobile wallet financial institution client application on the customer device 110 or via a wallet functionality integrated into the financial institution client application 116), a bill payment icon enabling the customer to view upcoming payments, as well as a deposit icon enabling the customer to transfer money to the customer's reserve account. In some embodiments, the navigation portion 552 includes an icon depicting a person-to-person payments functionality enabling the customer to select a person to transfer funds from the customer spending account to. Additionally, the navigation portion 552 includes a navigation dialogue box 530 as described with respect to FIG. 5C.

Referring now to FIG. 5F, an example account balance graphical user interface 554 is shown. In some embodiments, the customer is presented the account balance graphical user interface 554 upon selecting the balance viewing icon 544 of the account management graphical user interface 538 described with respect to FIG. 5E. As shown, the account balance graphical user interface 554 includes the balance view portion 538 described with respect to FIG. 5E, a spending account portion 556, and a reserve account portion 558. The spending account portion 556 includes a current balance of the customer's spending account. In embodiment, the balance shown corresponds to the amount shown in the spending limit portion 538. In some embodiments, the customer may select the spending account portion 556 to be brought to an additional interface containing a listing of various transactions conducted by the customer. The reserve account portion 558 lists allocations of the customer's funds placed in the customer reserve account. For example, the reserve account portion 558 may include a first amount that is scheduled to be transferred to the customer spending account (e.g., corresponding to a customer spending limit), a second amount that is allocated towards the customer's savings, and a third amount that is allocated to upcoming payments owed by the customer. In some embodiments the account balance graphical user interface 554 includes a total account balance portion 559 including depictions of the total amount of funds that the customer has available, as well as any portions of those funds that are unallocated.

Referring now to FIG. 5G, an allocation graphical user interface 560 is shown, according to an example embodiment. In some embodiments, the user may be presented with the allocation graphical user interface 560 upon the customer selecting the unallocated funds identified via the account balance graphical user interface 554 described with respect to FIG. 5F. As shown, the allocation graphical user interface 560 includes an unallocated funds portion 562 and an allocation portion 566. The unallocated funds portion 562 includes a depiction of an amount of funds that the customer is yet to allocate and an automatic allocation button 564 configured to receive a customer input to run the allocation prioritization algorithm (e.g., described with respect to FIG. 4) to generate a suggest allocation for the unallocated funds.

The allocation portion 566 includes a plurality of entries 568, 570, and 572. Each of the entries 568, 570, and 572 is associated with an envelope to which the customer may add a portion of the unallocated funds to. As will be appreciated, the allocation graphical user interface 560 may include any number of entries. In the example shown, the entry 568 is associated with a spending re-load envelope. The spending reload envelope depicts to the customer an amount that is scheduled to be transferred to the customer spending account upon the expiration of a period associated with the customer spending limit (e.g., at the beginning of the next week). The entry 570 depicts the current balance of the customer spending account, and the entry 572 depicts an amount currently allocated to an electric bill of the customer. Each entry includes a slide bar depicting a range of amounts that may be associated with each envelope if the customer allocates a portion of the unallocated funds to the envelope. In various embodiments, the customer may select each of the slide bars and allocate a portion of the unallocated funds to each envelope.

FIG. 5H shows an updated allocation graphical user interface 574 that is presented to the customer upon the customer allocating a portion of the unallocated funds to a particular envelope. In the example shown, the customer has allocated a portion of the funds to the envelope associated with the entry 568. Such an action results in each of the slide bars being updated. In the entry 568, the slide bar has been updated to reflect the amount that the customer has allocated to that envelope. The slide bars of the entries 570 and 572 have been updated to reflect the maximum amount that may be allocated to each of the associated envelopes given the customer's previous allocation to the envelope associated with the entry 568.

FIG. 5I shows an updated allocation graphical user interface 576 that is presented to the customer upon the customer allocating the remaining portion of the unallocated funds to the envelope associated with the entry 572. As shown, the entry 572 has been updated to reflect the customer's allocation. The allocation graphical user interface 576 also includes an allocation completion button configured to receive a customer preference to save the indicated allocation preferences.

Referring now to FIG. 5J an example functionality graphical user interface 574 is shown. In some embodiments, the functionality graphical user interface 574 is presented to the customer upon the customer entering a particular item into the navigation dialogue box 530 of the account management graphical user interface 536 described with respect to FIG. 5E. In the example shown, the customer has input the term “electric” into the navigation dialogue box 530. In response, the customer device 110 accesses a directory of functionalities and lists functionalities in the directory that are associated with the customer-input item. As shown, the functionality graphical user interface 574 includes a results portion 576 listing the results as well as a commonly used functionality portion 578. The results portion 576 lists entries associated with the item that the customer input into the navigation dialogue box 530. As shown, the entries are selectable and enable the customer to take a variety of actions with respect to the customer's electrical bill such as viewing the bill, changing an amount allocated to the bill, and reading a security guarantee associated with the bill. The commonly used functionality portion 578 may show up each time the customer inputs an item in the navigation dialogue box 530.

In some embodiments, the entries in the commonly used functionality portion 576 are populated based on the customer's history of using the financial institution client application 116. For example, each time the customer accesses a particular feature of the financial institution client application 116, the customer device 110 may add an entry to a customer activity log. To populate the commonly used functionality portion 576, the customer device 110 may access the activity log and identify a predetermined number (e.g., two) of functionalities that have been used the most within a predetermined period (e.g., a month). As such, the commonly used functionality portion 576 may be dynamically updated based on the customer's utilization of the financial institution client application 116. Thus, the navigation dialogue box 530 provides the customer with access to both a specific subset of functionalities (e.g., associated with the term the customer enters) as well as the functionalities most commonly used. This enables the customer to efficiently navigate through the financial institution client application 116.

Referring now to FIG. 5K, a financial summary graphical user interface 580 is shown. In some embodiments, the financial summary graphical user interface 580 may be accessed via the account management graphical user interface 536 described with respect to FIG. 5E. For example, the customer may swipe and drag a location on the account management graphical user interface 536 to access the financial summary graphical user interface 580. As shown, the financial summary graphical user interface 580 includes a category spending portion 582 and a financial trends portion 584. As shown, the category spending portion 582 includes each of the icons 370, 372, 374, 376, 378, and 380 described with respect to FIG. 3K. Each of the icons 370, 372, 374, 376, 378, and 380 is updated to include an amount spent by the customer within a predetermined period (e.g., since the customer spending time was loaded with funds). Additionally, the icons 370, 372, 374, 376, 378, and 380 have been re-sized such that they have a size that corresponds with the spending amounts. Thus, the customer is able to efficiently view the category in which the customer spends the most money.

The financial trends portion 584 includes graphical depiction of the customer's finances. For example, the financial trends portion 584 includes graphs depicting the customer's level of spending, bill payments, and account balance over the course of a number of months. Each graphical depiction includes a target amount as well as an average amount. For example, in one embodiment, the graphical depiction of the customer's level of spending includes the customer's spending limit as well as the average level of customer spending. This way, the customer is able to efficiently view their spending in relation to a target level. As such, the financial summary graphical user interface 580 provides the customer with a broad overview of aspects of the customer's financials.

Referring now to FIG. 6, a method 600 of allocating a customer deposit into the customer spending and reserve accounts is shown, according to an example embodiment. The method 600 may be performed by components of FIG. 1 such that reference to components of FIG. 1 may be made to aid the description of the method 600. The method 600 may be executed by, for example, the account management circuit 124 of the financial institution computing system 120 or the customer device 110 to allocate customer funds amongst various payments owed by the customer to recipients and to transfer funds from the customer reserve account to the recipients.

At process 602, an indication of a deposit to the customer's spending account is received. In some embodiments, the customer may enter information regarding an alternative banking account of the customer and a deposit amount into a funding interface (e.g., similar to the graphical user interface 336 discussed with respect to FIG. 3G) presented to the customer via the financial institution client application 116. In response, the customer device 110 may transmit the information to the financial institution computing system 120 which may process the request and transfer funds into the customer spending account. In some situations, the indication of the deposit is received from an external computing system. For example, an employer of the customer may transfer funds from an employer account to the customer spending account as a direct deposit.

At process 604, the deposit to the customer's spending account is allocated to the customer's spending and reserve accounts based on a customer spending limit. For example, the account management circuit 124 may determine a current balance of the customer's spending account and compare the amount to a customer spending limit. If the current balance is below the spending limit, the account management circuit 124 may allocate a portion of the deposit corresponding to the difference to the customer spending account. Alternatively or additionally, the account management circuit 124 may allocate a predetermined amount to the customer spending account. The predetermined amount may be determined based on a deposit schedule (e.g., based on the customer's income and the frequency that the customer receives deposits from an employer). The predetermined amount may be set such that an amount corresponding to the customer spending limit is transferred into the customer spending account each spending limit period (i.e., the period to which the customer spending limit applies, such as a month). In some embodiments, after the initial deposit into the customer's spending account, the remaining funds are allocated to the reserve account.

At process 606, upcoming payments owed by the customer are identified. In some embodiments, the account management circuit 124 retrieves information regarding customer expenses from the accounts database 126 (e.g., information regarding bills or other expenses of the customer), and identifies payments owed by the customer within a predetermined period (e.g., week, month, etc.). In some embodiments, the account management circuit 124 requests information regarding customer expenses from external computing systems and identifies the upcoming customer payments based on information received from such external systems. In some embodiments, the customer device 110 requests such information from the financial institution computing system 120, which may return the information to the customer device 110 for identification of the upcoming payment of the customer.

At process 608, the total amount of the upcoming payments owed by the customer is compared with the current balance of the reserve account balance. If the customer has sufficient finds in the customer reserve account, method 600 moves on to process 616 to transmit funds to recipients of the upcoming customer payments. However, if there are insufficient funds in the customer reserve account to make all of the upcoming payments owed by the customer, additional funds are requested from the customer at process 610. In an embodiment, the account management circuit 124 facilitates a push notification being provided to the customer (or any other type of notification and request to the customer). An example push notification is described with respect to FIG. 7E. The push notification may prompt the customer to access the financial institution client application 116, which may cause the customer device 110 to present the customer with a prompt (e.g., via a message) to indicate if the customer has any additional funds to report. An example of such a message is described with respect to FIG. 7F.

At process 612, a determination is made whether the customer provided sufficient funds to timely make the upcoming payments owed by the customer. Such a determination may be made by either the customer device 110 or the account management circuit 124 based on a customer response to the message presented to the customer at process 610. If the customer provided sufficient funds to timely make the upcoming payments the method 600 advances to process 616 to transmit funds to the recipients of the customer's upcoming payments. However, if the customer did not provide sufficient funds, the customer's funds in the customer reserve account are allocated between upcoming customer payments at process 614. For example, the account management circuit 124 may generate an allocation using the prioritization algorithm described herein.

At process 616, funds are transferred to recipients of upcoming customer payments. For example, using information provided by the customer during the method 200 described with respect to FIG. 2, the account management circuit 124 may formulate transaction requests on dates pre-set by the customer to various entities to which the customer owes payment. In some embodiments, the funds are transferred directly from the customer reserve account to the recipients of the upcoming customer payments. In alternative embodiments, the funds are first transferred from the customer reserve account to the customer spending account prior to being transferred to the recipients.

Referring now to FIG. 7A, an example notification graphical user interface 700 including a push notification 702 is shown. In some embodiments, the financial institution computing system 120 (e.g., via the account management circuit 124) is configured to cause the push notification 702 to be provided to the customer device 110 (e.g., via a push notification service) upon the receipt of funds from an external entity (e.g., an employer) directed to the customer's spending and reserve accounts. In various embodiments, the push notification 702 includes a call to a function of the financial institution client application 116 that causes the home screen of the financial institution client application 116 (e.g., the account management graphical user interface 516 described with respect to FIG. 5C) to update.

Referring now to FIG. 7B, an example updated account management graphical user interface 704 is shown. As shown, the updated account management graphical user interface 704 shares many of the same features as the account management graphical user interface 516 described with respect to FIG. 5C, except the updated account management graphical user interface includes an updated dynamic icon 706 including information regarding the customer deposit. For example, in one embodiment, the updated dynamic icon 706 includes the amount of the deposit, an allocation of the deposit between the customer spending account and the customer reserve account, and a customer preference indicator 708. Via the customer selection indicator 708, the customer may indicate a preference to accept the depicted allocation or to make an adjustment to the depicted allocation.

FIG. 7C shows an example allocation graphical user interface 709. In some embodiments, the customer is brought to the allocation graphical user interface 709 when the customer indicates a preference to adjust the allocation depicted in the updated dynamic icon 706 of the updated account management graphical user interface 704 described with respect to FIG. 7B. The allocation graphical user interface 709 includes payment portions 710 and 712 and a spending portion 714. The spending portion 714 indicates an amount of a recent deposit into the customer's spending and reserve accounts has been allocated to the customer's spending account. Payment portions 710 and 712 indicate to the customer an amount and due date of upcoming payments owed by the customer. Each of the payment portions 710 and 712 includes an adjustable slide bar that enables the customer to adjust an amount of the deposit that is allocated to each payment. In response to the customer making an adjustment to the allocation, the provided allocation may be stored at the customer device 110. Additionally, when the customer has allocated a sufficient amount (e.g., a total amount owed or a minimum amount owed) to a particular payment, the payment portions 710 and 712 may update to include payment buttons that may cause the customer device 110 to transmit instructions to the financial institution computing system 120 to transfer the indicated amount of funds from the customer reserve account to the depicted entity.

FIG. 7D shows an example updated account management graphical user interface 716. In various embodiments, the customer may be presented with the updated account management graphical user interface 716 in response to the customer selecting the transaction icon 528 of the account management graphical user interface 516 described with respect to FIG. 5C. As shown, the transaction icon 528 is expanded to include a summary of expected cash flows of the customer within a predetermined period (e.g., a month). The expanded transaction icon 528 includes an expected amount of customer income to be received (e.g., based on a customer direct deposit) as well as a total amount of payments owed by the customer. This way, the customer is quickly able to view whether sufficient funds are available to make the expected payments.

FIG. 7E shows an example funding notification graphical user interface 718 including a deficient funds notification 720. In various embodiments, the financial institution computing system 120 (e.g., via the account management circuit 124) transmits the deficient funds notification 720 to the customer device 110 upon determining that the total amount of upcoming payments owed by the customer exceeds an amount of funds in the customer reserve account (e.g., at process 608 of the method 600 described with respect to FIG. 6). In various embodiments, the deficient funds notification 720 includes a call to a function of the financial institution client application 116 to cause the customer device 110 to present the customer with a message prompt upon the customer accessing the financial institution client application 116.

FIG. 7F shows an example messaging graphical user interface 722 according to an example embodiment. In some embodiments, the financial institution client application 116 causes the customer device to present the customer with the messaging graphical user interface 722 after the customer receives the deficient funds notification 720. As shown, the messaging graphical user interface 722 includes an initial message 724 notifying the customer of a fund deficiency, a query 726, a customer response 728, an allocation suggestion message 730, and a customer preference indicator 732. For example, the customer device 110 may formulate the initial message 724 based on account balance information and customer payment information received from the financial institution computing system 120. The allocation suggestion message 730 may be generated by the customer device 110 based on a reallocation of funds in the customer reserve account calculated by either the financial institution computing system 120 or the customer device 110. The customer preference indicator 732 is configured to receive an input to accept the suggested allocation or to make an adjustment. If the customer accepts the allocation, the customer device 110 may provide a notification signal to the financial institution computing system 120 which may update the allocation of the funds in the customer reserve account. If the customer does not accept the allocation, the customer may be brought to an interface similar to the allocation graphical user interface 709 described with respect to FIG. 7C.

In various embodiments, the financial institution client application 116 includes a messaging applet configured to generate messaging graphical user interfaces in response to certain determinations being made regarding the customer's finances. In this regard, the messaging applet may include messaging templates that are retrieved in response to certain triggers (e.g., the customer spending above or below the customer spending limit, the customer having insufficient funds in the customer reserve account to make an upcoming payment, a detected change in the customer's income). Each messaging template may have an associated set of responses that may be presented as options to respond to the messages presented to the customer. Additional message templates may be presented to the customer based on the customer's responses to the messages. As such, rather than presenting the customer with multiple graphical user interfaces to notify the customer and enable the customer to perform a needed action, the financial institution client application 116 efficiently presents all of such information to the customer via a single interface in an interactive manner.

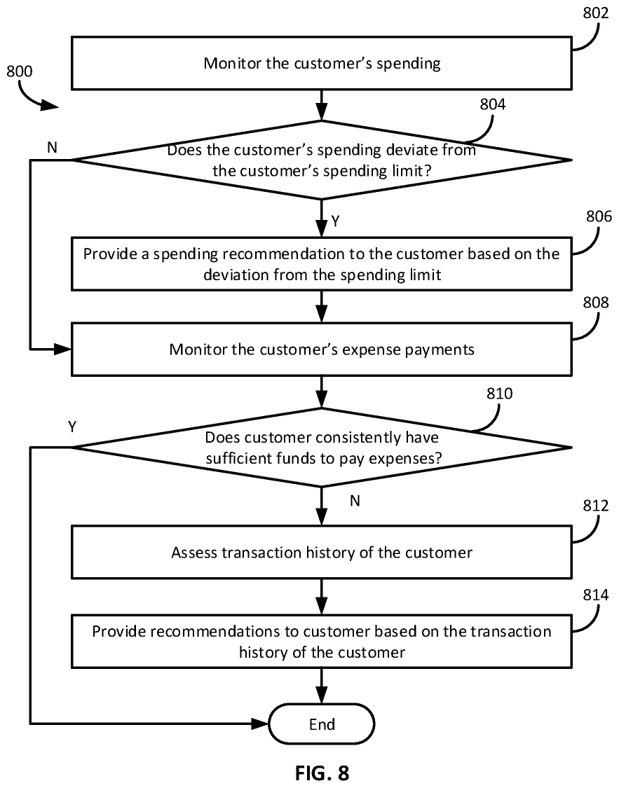

Referring now to FIG. 8, a flow diagram of a method 800 of monitoring the financial activity of a customer and providing recommendations to the customer is shown, according to an example embodiment. Method 800 may be performed by the components of FIG. 1 such that reference may be made to the components of FIG. 1 to aid in the description of the method 800. The method 800 may be executed by the account management circuit 124 or customer device 110 to provide financial advice to the customer based on the customer's spending behavior.

At process 802, the account management circuit 124 monitors the customer's spending habits and activities. For example, the account management circuit 124 may retrieve a transaction history of the customer and determine an amount spent by the customer within various predetermined periods. At process 804, the account management circuit 124 compares the customer's spending levels to the customer's spending limit and determines whether the customer's spending amount differs from the spending limit by more than various thresholds. If not, method 800 advances to process 808 to monitor the customer's expense payments. In some embodiments, the customer device 110 performs such an analysis upon receipt of the customer's transaction history from the financial institution computing system 120.

However, if the customer's spending behavior deviates from the customer's spending limit by more than a threshold amount, the account management circuit 124 provides a spending recommendation to the customer at process 806. For example, if the customer consistently spends more than the customer spending limit (e.g., the customer spends more than the spending limit in more than predetermined percentage of weeks), a recommendation to cut spending may be provided. Such a recommendation may identify particular transactions of the customer that are selected by comparing characteristics of the customer's transactions (e.g., amounts, merchants, timing) with transactions of other customers of the financial institution. If the customer engages in transactions or patterns of transactions avoided by other customers having a similar income as the customer, for example, the recommendation to cut spending may identify the transactions. In some embodiments, the recommendation enables the customer to establish transaction rules for the customer spending account such that, upon the customer attempting to engage in one of the identified transactions, the transaction is either denied or an alert may be provided to the customer.

If the customer consistently spends amounts below the customer spending limit, the account management circuit 124 or customer device 110 may provide advice as to what the customer should do with the extra funds. For example, a recommendation may be provided for the customer to establish a savings or investment account.

At process 808, the account management circuit 124 monitors payments of the customer's expenses. For example, based on customer transaction information stored at the accounts database 126 (e.g., describing amounts owed by the customer to external entities by certain dates and amounts paid by the customer), the account management circuit 124 may determine if the customer consistently makes such payments timely at process 810. If so, the method 800 may end.

However, if the customer does not consistently make such payments, the account management circuit 124 may assess the transaction history of the customer at process 812 to identify negative customer spending habits (e.g., by comparing the customer's spending transactions to transactions of other customers of the financial institution). Based on such habits, the account management circuit 124 may provide recommendations to the customer at process 814. For example, the recommendation may prompt the customer to transfer funds from the customer spending account to the customer reserve account and/or lower the customer's spending limit. The recommendation may also describe transactions that the customer should avoid to accommodate for such changes. Alternatively or additionally, the recommendation may include suggestions as to the customer's expenses. For example, the recommendation may suggest that the customer discontinue receiving a service from a particular service provider (so as to lower the total amount of the customer's bill payments) if the total amount of the customer's bills each month differs from that of other customers having a similar income to the customer.

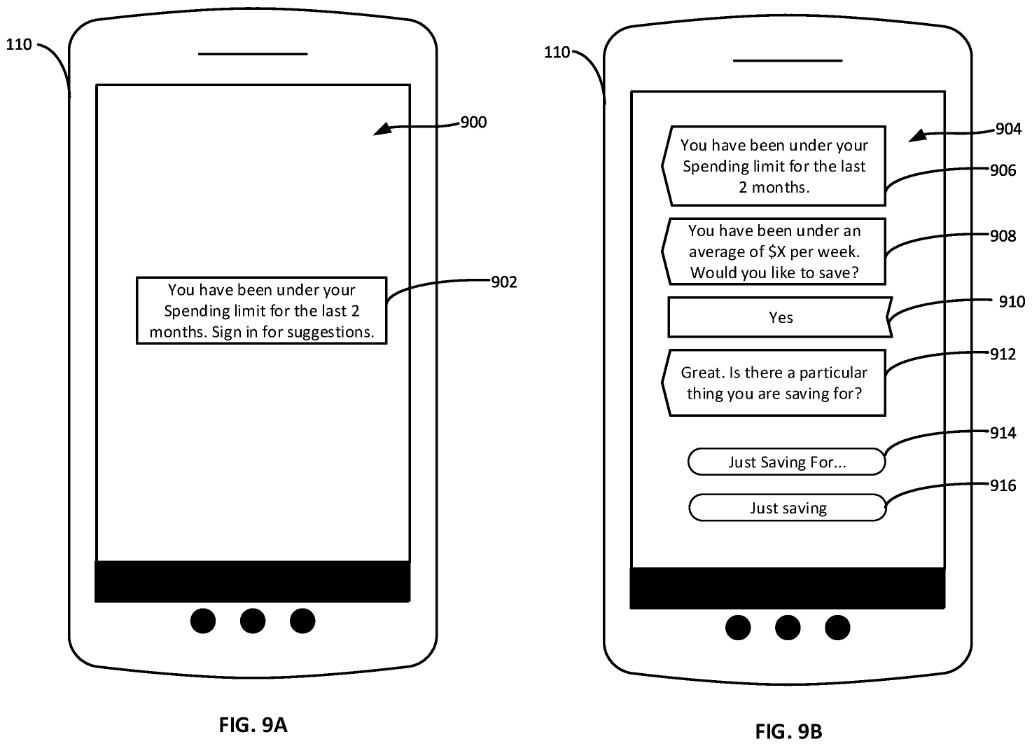

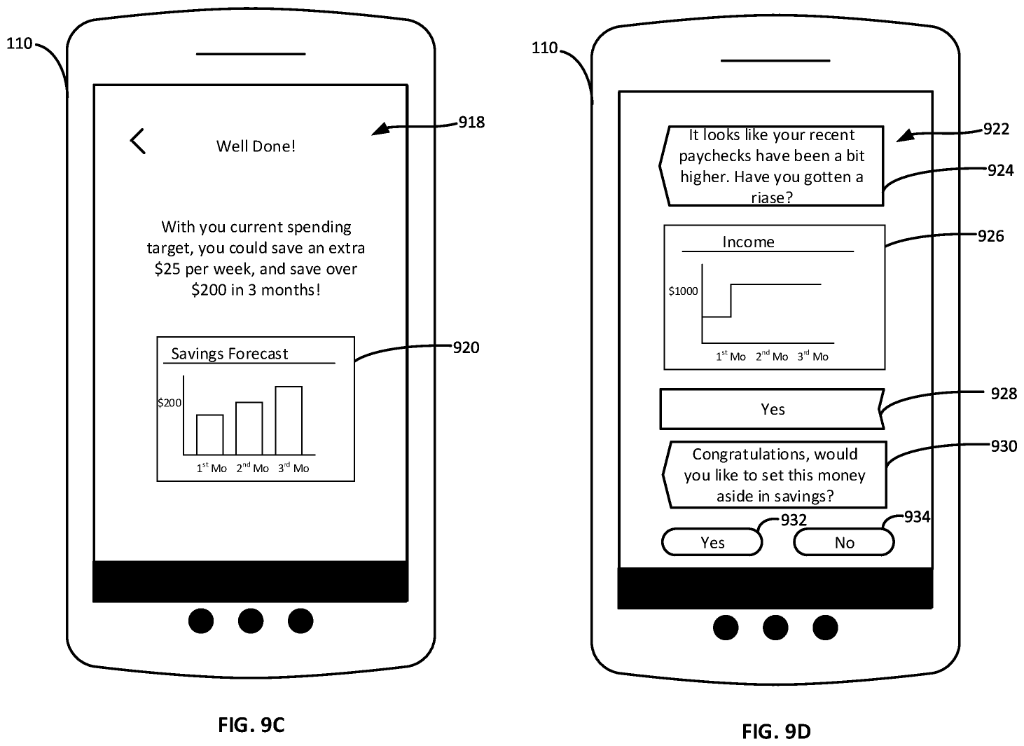

FIG. 9A shows an example spending notification graphical user interface 900 including a spending trend notification 902. In various embodiments, the financial institution computing system 120 (e.g., via the account management circuit 124) transmits spending trend notification 902 to the customer device 110 upon determining that the customer's spending is consistently below the customer's spending limit. Alternatively, the customer device 110 may generate such a notification upon making such a determination. In various embodiments, the spending trend notification 902 includes a call to a function of the financial institution client application 116 to cause the customer device 110 to present the customer with a message prompt upon the customer accessing the financial institution client application 116.

FIG. 9B shows an example recommendation messaging graphical user interface 904 that may be presented to the customer upon the customer accessing the financial institution client application 116 after receiving the spending trend notification 902. The recommendation messaging graphical user interface 904 includes a spending notification messages 906 and 908, a customer response 910, a customer naming prompt 912, and customer naming options 914 and 916. The spending notification messages 906 and 908 indicate to the customer how much the customer has deviated from the customer's spending limit and also ask the customer if the customer would like to start saving funds. In response to the customer indicating such a preference in the customer response 910, the customer naming prompt 912 and customer naming options 914 and 916 may be presented to the customer. The customer naming option 914 enables the customer to manually input a name for the customer's saving account. The customer naming option 916 enables the customer to provide a default name for the customer's saving account.

Upon the customer naming the savings account, the account management circuit 124 may establish a savings account for the customer and periodically transfer the indicated amount of funds (e.g., the average amount the customer spends below the customer spending limit) from the customer's spending account the savings account. Thus, technically and beneficially, the systems and methods herein enable customers to dynamically establish accounts based on the customer's current financial situation.

Referring now to FIG. 9C, a savings forecast graphical user interface 918 is shown, according to an example embodiment. In various embodiments, the savings forecast graphical user interface 918 is presented to the customer automatically upon the customer device 110 and/or financial institution computing system 120 determining that the customer's current spending behavior creates the potential for the customer to set aside additional funds for savings. For example, in one embodiment, the customer device 110 aggregates the customer's current spending limit with other allocations of the customer's funds (e.g., to upcoming payments owed by the customer and an amount set aside for a savings fund). The customer device 110 also projects amounts that will be deposited into the customer spending and reserve accounts (e.g., based on previous deposits made by the customer). The aggregated amount is then compared with the projected deposit amount and, if the projected deposit amount is greater than the aggregated amount, then the customer has the potential to save funds. In such cases, the customer device 110 may generate a customer savings forecast based on the extent to which the projected deposits exceed the aggregated amount. Once the savings forecast is generated, the customer device 110 may notify the customer (e.g., via a notification interface similar to that described with respect to FIG. 9A) and/or configure the financial institution client application 116 to present the savings forecast graphical user interface 918 to the customer upon the customer accessing the financial institution client application 116 on the customer device 110. In some embodiments, the customer device 110 may project a customer savings forecast in response to the customer indicating a request to view the savings forecast (e.g., via the navigation dialogue box 530 described with respect to FIG. 5C).

Referring now to FIG. 9D, a recommendation messaging graphical user interface 922 is shown. In various embodiments, the recommendation messaging graphical user interface 922 may be presented to the customer upon the financial institution computing system 120 or customer device 110 identifying an indicator that the customer's income has increased. For example, upon receiving a deposit into the customer reserve account, the financial institution computing system 120 (e.g., via the account management circuit 124) may compare the amount of the deposit with customer's previous deposits to determine that the deposit is greater than previous deposits. Alternatively or additionally, the financial institution computing system 120 may assess the customer's deposit history for patterns that are indicative of an increase in the customer's income. For example, a sudden increase in the amount of direct deposits may indicate that the customer has received at raise at her employment. Upon identifying such an indication, the financial institution computing system 120 may provide a notification to the customer device 110, which may be similar in form to the spending notification graphical user interface 900 described with respect to FIG. 9A. As described herein, such a notification may cause the customer device 110 to present the customer with the recommendation messaging graphical user interface 922 upon the customer accessing the financial institution client application 116.

As shown, the recommendation messaging graphical user interface 922 includes an initial message 924 indicating the identified deposit pattern to the customer, as well as a graphical depiction 926 of recent deposits into the customer's account. As shown, the initial message 924 prompts the customer to confirm whether the customer has received a raise. If the customer responds in the affirmative (as indicated by the customer response message 928), the customer device 110 may generate a response message 930 that indicates that, if the customer's spending limit is maintained, the customer may set aside additional money into savings. In some embodiments, the response message includes a savings forecast (e.g., similar to the savings forecast 920 described with respect to FIG. 9C), and includes a query requesting a customer preference. In addition to the response message 930, the customer device 110 also causes preference options 932 and 934 to be presented to the customer. The preference options 932 and 934 are configured to receive customer inputs to set aside funds for savings within the customer reserve account. In response to the customer selecting the preference option 932, the customer device 110 may present the customer with an additional interface enabling the customer to indicate an amount to set aside.

Referring back now to FIG. 5G, as indicated above, the allocation graphical user interface 560 includes an unallocated funds portion 562 and an allocation portion 566. The allocation portion 566 includes a plurality of entries 568, 570, and 572. The entries are entered into the customer device 110 by a user, and transmitted to the account management circuit 124 as described and referenced above. In some embodiments, the account management circuit 124 may use one or more of the entries 568, 570, and/or 572 and create envelopes for each of the one or more entries 568, 570, and/or 572. As described herein, an “envelope” is a fund repository (e.g., savings location, holding account, etc.) that is earmarked for a certain purpose (e.g., electric bill, cable bill, revolving credit savings account). The certain purpose is defined by or otherwise associated with the entry entered in by the user (e.g., entries 568, 570, and 572) within the checking account (e.g., the user reserve account). Each envelope is be managed by the account management circuit 124, and may have individualized preferences (e.g., payment rail designation, savings rules, etc.). In other words, the reserve account includes a plurality of envelopes, and each of the plurality of envelopes is associated with one of the entries 568, 570, 572 (one entry per envelope). According to one embodiment and as described in more detail below, each (or at least one) of the envelopes may be tokenized (i.e., tokenized envelopes). As described below and beneficially, the additional tokenization as applied to the envelopes provides for enhanced security due to the obfuscation of account numbers related to the checking account.

In some embodiments, the account management circuit 124 may create an envelope for each one of the entries 568, 570, and 572. In some embodiments, the account management circuit 124 may create an envelope for only certain types of entries 568, 570, and 572. For example, in an embodiment, the account management circuit 124 may only create envelopes for bills, loan payments, or other recurring items (i.e., envelopes for only recurring payments). The account management circuit 124 may create an envelope automatically after determining that a recurring charge appears in the checking account. For example, the account management circuit 124 may determine that a charge from a single payee (e.g., a cable company, music streaming company, etc.) is applied each month on the same day (e.g., the 24th). After a predefined time period of recognizing/continuously identifying the single payee, the account management circuit 124 may automatically generate an envelope corresponding to that single payee in order to facilitate better financial planning for the user. In some embodiments, the account management circuit 124 may create an envelope after determining that the customer account is tied to other accounts (e.g., a credit card account, a Venmo® account, etc.). For example, the user may select via an icon displayed on the customer device 110, via application 116, to add an external account. The user may then select which type of account (e.g., a credit card account or checking account through a different financial institution) that they would like to add. The customer device 110 may then prompt the user via the financial institution client application 116 to enter in the user's online login credentials for the external account. The customer device 110 may then attempt to login to the external account via the customer device 110 and interface with the external account (e.g., exchange data) with the external account. In response to receiving the login information and/or logging into the external account, the customer device 110 may create an envelope for that external account. In other embodiments, the customer device 110 may send the login credentials to the account management circuit 124. The account management circuit 124 may then establish an application-programming interface with the external account or a server of the external account provider in order to receive information regarding the external account. In response to receiving the login credential or establishing the API, the account management circuit 124 may automatically create an envelope associated with the external account.

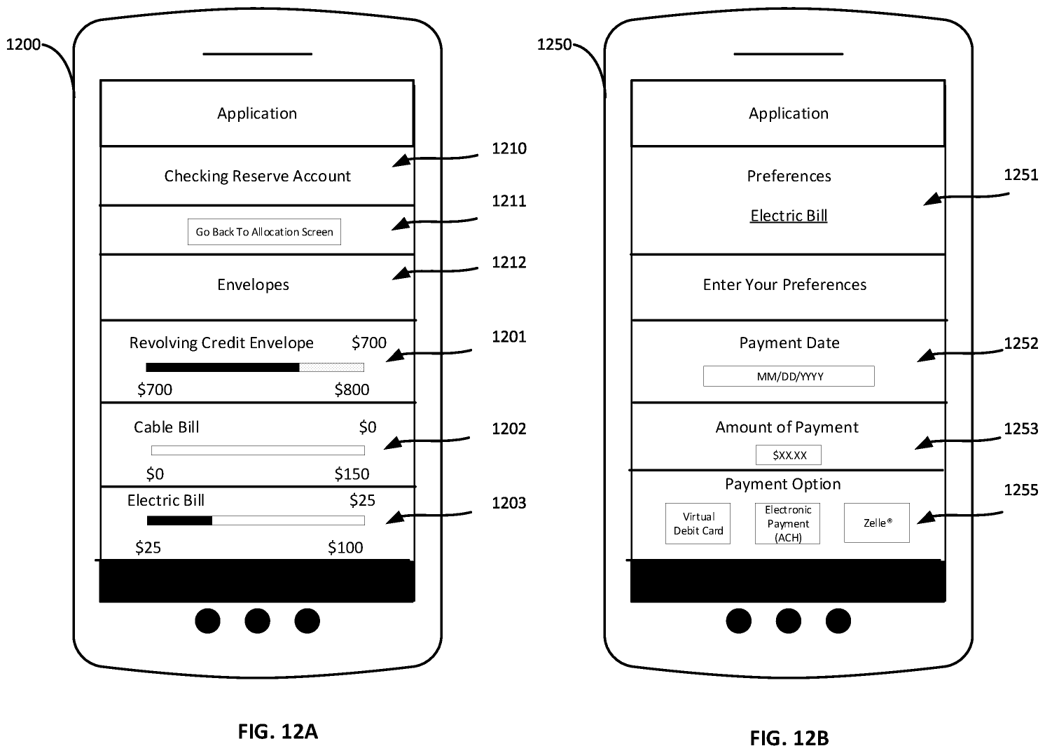

Referring now to FIG. 12A, a graphical user interface displayed on a customer device 1200 is depicted in accordance with an example embodiment. FIG. 12B depicts a preference screen 1250 displayed on a customer device 110 in accordance with an example embodiment. The graphical user interface 1200 is shown to include a list of the envelopes 1212 within the reserve account 1210 and an option to return to enter more entries 1211 (e.g., such as in reference to FIG. 5). While there may be multiple envelopes, in the example shown, the graphical user interface 1200 includes a revolving credit envelope 1201, a cable envelope 1202, and an electric bill envelope 1203. In other embodiments, more or different envelopes 1212 may be depicted on the graphical user interface after entries (e.g., such as the entries made in FIG. 5G) have been made into the customer device 110.

In one embodiment, each or some of all of the envelopes may be tokenized. For example, a first envelope may have a first payment token assigned by the account management circuit 124 and a second envelope may have a second payment token. The first payment token and the second payment token may be generated by making separate token requests (or one request for two separate tokens) to a token provider (e.g., Mastercard, Visa, American Express, etc.). The token provider may provide the token(s) in response to the request. In some embodiments, the request for the first and second tokens are made automatically after the account management circuit 124 creates the first and second envelopes. In some embodiments, the token provider is the financial institution computing system 120, such that this action and others pertaining to this action may be done by the financial institution computer system 120 (i.e., token generation for the envelope(s) may be done by, e.g., the account management circuit 124). In other embodiments, the first payment token may be provided by a first token provider (e.g., Mastercard) and the second payment token may be provided by a second token provider (e.g., Visa) that is different form the first token provider.

Each envelope may be designated for use with a specific payment rail (e.g., ACH, wire transfer, real-time transfer, etc.) as the mechanism for transferring funds out of that specific envelope. That is, a user may select in a preference screen 1250 a payment option 1255 for each envelope to use for transferring funds out of the envelope to an intended payee. In an example, the payment options may include a virtual debit card (described in detail below), a direct electronic payment, or an external option such as Zelle®. For example, if the user selects the virtual debit card, the account management circuit requests a token from a token provider, assigns a payment account number, expiration date, and security code (e.g., CVV) to the envelope and displays the information, or a subset thereof, to the user. If the user selects the direct electronic payment, the account management circuit 124 may request a token from the token provider, and prompt the user via a graphical user interface on the customer device 110 for login credentials to an online account associated with the envelope (e.g., electric company online account), the account management circuit 124 may then interface directly with the online account via an API and send the payee (e.g., the electric company) the token to use to initiate payments. In another example, the user may need or desire to pay a person, such as a roommate for a portion of the electric bill. As a result, the user may select a P2P payment option, such as Zelle®. The account management circuit 124 receives this preference information/indication from the customer device 110 and governs the corresponding envelope accordingly. It is to be appreciated that each of these are example and more or fewer payment options 1255 may be available to be utilized. The account management circuit 124 then receives the selected payment options/preferences 1255 from the customer device 110 and facilitates future payments according to the entered preferences received from the customer device. If the customer device 110 does not transmit preferences to the account management circuit 124, the account management circuit 124 may use default preferences or rules. In other embodiments, more or fewer preferences may be provided.

In an embodiment, the account management circuit 124 may assist with funding the envelopes after each of the envelopes are created. In the example shown, the envelope 1203 depicts an amount currently allocated to an electric bill envelope 1203 of the user. The account management circuit 124 may automatically fund the electric bill envelope 1203 with a predicted amount of funds based on previous electric bills. For example, the account management circuit 124 may automatically fund the electric bill envelope 1203 with the same amount of funds that were paid to the electric company last month. In some embodiments, the account management circuit 124 may fund the electric bill envelope 1203 based on received information (e.g., via an API with the electric company) from an account of the user at the electric company. For example, the account management circuit 124 may have an application-programming interface (API) with a server associated with the electric company. The account management circuit 124 may provide information regarding the user (e.g., login information, social security number, etc.) to authenticate access of the account management circuit 124 to an account on the user with the electric company. The account management circuit 124 may then interface with the server associated with the electric company to pay the electric bill of the user directly, receive information regarding the cost of the electric bill each month, or transmit a token of the tokenized envelope to the electric company to use in facilitating the payment each month.

As alluded to above, in one embodiment, one or more of the envelopes may be tokenized. The token may be a unique numeric or alphanumeric sequence of characters that is value-less by itself. In operation, the token is generated (by, e.g., the account management circuit 124) and assigned to a particular envelope. This token may also be stored by the financial institution computing system 120. When this token is received from, e.g., a payee (e.g., the cable company), the financial institution computing system 120 (e.g., account management circuit 124) may map that token to the associated account number for payment process. Therefore, the account number of the reserve account where the envelopes or housed/stored/located is not used in the transaction. Further, the token may include one more parameters that define the characteristics of the payment (e.g., frequency, amount, payee, payment date, payment rail, and so on). In a non-conventional manner, multiple unique tokens may be assigned and used with one account (a token for each envelope of the reserve account). This configuration may speed up transaction processing when the transaction is initiated, but is not an intuitive structure due to the additional levels of security being provided and the computing resources used to initially provide that security. As an example, in one embodiment, the electric bill envelope 1203 may be tokenized. As such, using the token associated with the envelope, the electric bill envelope 1203 pays the electric bill from the electric bill envelope 1203. The token for the envelope may be requested from a token provider (e.g., Mastercard®) and used for a specific payment to a payee. Alternatively, the token may be generated by the financial institution computing system (e.g., account management circuit 124) and then assigned to the envelope. For example, a token for the electric bill envelope 1203 may be requested by the account management circuit 124 and received by the account management circuit 124 from the token provider. The token may then be provided to the electric company. In this way, the transaction between the electric bill envelope 1203 and the electric company is facilitated via the token and processed using the token. Beneficially, the account management circuit 124 can ensure that only the electric company has access to the electric bill envelope 1203 and can block all other transactions from requestors that are not or do not appear to be the electric company, thereby enhancing security. The advantages of the tokenized envelopes are that each envelope has a unique token, which enhances security and creates less processing requirements. For example, security is increased because if one of the tokens for one of the envelopes are compromised, then only the funds in that specific tokenized envelope may be compromised. Further, less processing needs are met because the token of a tokenized envelope is unique to the envelope, which requires less intensive processing for the account management circuit 124 to determine which envelope that a transaction should pull from (and the amount).

The token of the tokenized envelope can be periodically updated (e.g., via requesting new tokens from the token provider), which lessens the probability that the token will get compromised. In one embodiment, the token is replaced with a new token monthly. In another embodiment, the token is replaced at a different periodic interval. In still another embodiment, the token may be replaced based on a different occurrence other than the passage of time, such as after a predefined number of uses. Parameters that govern when the token may be replaced include, but are not limited to, the payee, the amount of the typical payment, the payment rail for the envelope, etc., and/or a combination thereof. For example, for envelope payments above a predefined threshold value, the token may be replaced after every use while payments under the predefined threshold value may not be replaced until after ten uses. As another example, a risk determination may be made with the payee and if the payee is determined high risk, the token may be replaced more frequently than if the payee is not determined to be high risk.

In some embodiments, the user may select specific payment rails for the electric bill envelope 1203. For example, the user may know that the electric company charges a fee for credit card transactions, thus the user may select that the electric bill envelope 1203 pays the electric company via a non-fee payment rail. That is, the user enters an account number and a routing number into the electric bills website to pay for the electric service. The account number may be unique to the reserve account. Alternatively, the account number may be unique to the electric bill envelope 1203. That is, the electric bill envelope 1203 may have a unique account number that directs the account management circuit 124 to pull only from the electric bill envelope 1203 when that account number associated with that envelope is provided to a payee. Thus, there may be multiple unique account numbers: one for each envelope. The unique account number also enhances security and reduces the potential of fraud. This unique account number-for-each-envelope may be an alternative embodiment to the tokenization of the envelope concept introduced above.

In another embodiment, the account management circuit 124 may determine a particular payment rail for each envelope. In some embodiments, the account management circuit 124 may analyze transactions made from each envelope and determine a better payment option. For example, the account management circuit may look at the accounts database 126 for other customers that transact with a similar or the same payee. In response to determining that other customers pay less in fees by transacting with the payee with a certain payment rail (e.g., ACH) the account management circuit 124 may automatically change the payment rail and/or notify the user of the potential benefits. Examples of how the account management circuit 124 may automatically change the payment rail or notify the user are explained later in this paragraph. In another example, in some embodiments, the account management circuit 124 may establish or otherwise use an API with a server of the payee of each envelope, as described above. The account management circuit 124 may use the API to analyze fees, transaction times, transaction dates, etc. and determine an optimized payment rail for transactions to the payee from the envelope. The optimized payment rail may reduce the fees associated with the transactions, increase or decrease settlement time for the transaction (e.g., if transaction is scheduled for the 29^{th}, but the user does not receive funds from an employer until the 30^{th}), etc. For example, the account management circuit 124 may determine that an ACH payment to the payee increases the settlement time for the transaction (e.g., based on a determination from historical information that ACH payments take one or two days to clear the account) and that there are no fees from the payee associated with ACH transactions. The account management circuit 124 may then automatically facilitate the transaction via the ACH payment rail. In other embodiments, the account management circuit 124 may send a prompt or notification to be displayed on the customer device 110 (e.g., in the application 116, as a text message, etc.), the prompt or notification may simply notify the user of the best payment rail, ask the user whether they would like the account management circuit 124 to implement this payment rail, or notify the user to manually change the payment rail in the preference screen.

The account management circuit 124 may also provide a bill splitting feature for one or more envelopes. For example, the electric bill may need to be paid to a roommate (e.g., the roommate pays the electric company), and thus the electric bill envelope 1203 (or token therefor) may be tied to an external peer-to-peer fund transfer system (e.g., Zelle®, Paypal®, or Venmo®). In an example, the user may select the entry 572 on the customer device 110 and be brought to a preferences screen where the user can select the payment method that the user would like to use to pay the roommate. That is, the user may select the peer-to-peer fund transfer system icon (Zelle®) on the preference screen 1250. The customer device 110 may react to the selection by redirecting the screen to a screen asking the user for information regarding the roommate's peer-to-peer fund transfer system information. The user may then enter the roommate's peer-to-peer fund transfer system information (e.g., the roommates handle). The customer device 110 may then store that information locally on the customer device 110 or send it to the account management circuit 124 to store the roommates information and the payment amount (e.g., entered in the preference screen 1250) such that the account management circuit 124 may facilitate the transaction via the peer-to-peer fund transfer system. In another example, the customer may enter into a preferences screen on the customer device 110 and enter in all of the preferences for the particular envelope (e.g., electric bill envelope 1203). That is, the customer may enter into the customer device 110 on the preferences screen 1250 that the electric bill envelope 1203 should be funded on a certain day of the month, paid to a specific payee on a specific day of the month 1252, an amount of that should be paid 1253, the method of payment (e.g., Zelle® to @exampleroomate). The customer device 110 may then transmit the preferences to the account management circuit 124 as rules to manage the envelopes.

In an example embodiment, a payment card may be provided by the financial institution computing system 120 for the reserve account. In some embodiments, the payment card may be a debit card, and in particular, a virtual debit card. As such, the virtual debit card is only available digitally on the customer device 110. In other embodiments, a different payment card or transaction card may be assigned to/issued for the reserve account (e.g., credit card, rewards card, etc.). Returning the virtual debit card embodiment, in one embodiment, the virtual debit card may be issued for a specific envelope within the reserve account. For example, the electric bill envelope 1203 may have a virtual debit card issued to the electric bill envelope 1203. In comparison, the cable bill envelope may have another virtual debit card issued and unique to the cable bill envelope. Alternatively, the virtual debit card may be specific to the reserve account overall and is, therefore, useable with all the envelopes (and payees) of the reserve account. The virtual debit card may be displayed on the customer device 110. In one embodiment, the issuer requests the virtual debit card in response to the customer selecting the virtual debit card option in the payment options 1255 section. The virtual debit card may have a specific payment account number (PAN), a specific expiration date, and a specific card verification value (e.g., CVV or CVV2), which can be displayed virtually to the customer for the customer to provide to a payee for any particular envelope. The virtual debit card allows for similar security functions as the tokenized envelopes. Unlike a credit card, the benefit with the debit card is that users can only spend funds that are in the account associated with the virtual debit card. Accordingly, and in alignment with the systems, methods, and apparatuses of the present disclosure, mechanisms that may help to build financial literacy and savviness in a controlled manner are provided. Further, if the virtual debit card information is compromised there are limited funds that are susceptible to also being compromised. The virtual debit card also allows for immediate access to the debit card information. That is, the customer does not have to wait for a plastic card to begin using the virtual debit card. It is to be appreciated that these are only a few examples.

In some embodiments, the account management circuit 124 may create an envelope to assist the customer with managing credit cards or other credit accounts. In particular, the account management circuit 124 may link a credit card (account and card) with the user's account. For example, a revolving credit account (e.g., credit card account) of the customer may be linked or otherwise associated with the checking accounts of the customer. The revolving credit account may be a credit card account associated with the customer that is provided by the provider of the checking accounts (or, in another embodiment, by a different issuer). An entry and envelope may be created for the revolving credit account, similar to the envelopes discussed above. In one embodiment, a user may add the credit card to the accounts (e.g., the spend account) by providing the spend account with data regarding the credit card via the client application 116. The client application 116 may transmit such data for identification and verification purposes to the account management circuit 124 creating and maintaining said account. An API may then be used to link the credit card account to the user's accounts associated with the application 116 (particularly, the spend account). In operation then, when the user uses the credit card, the charge is automatically or nearly automatically communicated (e.g., sent, transmitted, provided, etc.) to the account management circuit 124 and/or client application 116. The communication of the purchase may be done via an API from an external issuer of the credit card (e.g., American Express®) or the communication of the purchase may be done internally if the purchase was made on a credit card associated with the checking account issuer (e.g., in response to a transaction approval). In response to the communication of the charge, the account management circuit 124 may create an envelope for the charge that is specific to the credit card (i.e., one credit card for one envelope). The application 116 may then display this credit card envelope. Alternatively, the application 116 itself may create the envelope for the credit card. In a departure from typical system, funds in at least one of the set aside or reserve account may then be transferred into that envelope for the credit card. Thus, the credit card envelope is funded in real time or near real time to reflect the amount charged to the credit card. If the amount may exceed the funds in the spend or reserve account, the transaction may be denied (e.g., a communication may be sent to the issuer of the credit card (if different from the financial institution) to deny the transaction). Thus, a real time spending limit for the credit card is imposed on the user. This helps to ensure that the user has sufficient funds from the reserve or spend account to fund their credit card purchases yet still enables the user to build credit. Deposit allocation to the credit card may be from the one or both of the spend account and the reserve account. In other words and as described above, the account management circuit 124 may automatically allocate an amount of funds that is equivalent to the purchase to the envelope 1201 of the revolving credit account. In some embodiments, in response to the communication of the purchase, the account management circuit 124 may prompt the customer and ask whether the customer would like to immediately transfer funds directly from any particular account to the envelope 1201 associated with the revolving credit account. In this way, the account management circuit 124 is reserving money for a future bill (e.g., the credit card bill) in real-time (e.g., automatically after receiving purchase information). Additionally, the revolving credit account envelope 1201 (e.g., the envelope reserved for holding money to be paid on the credit card bill) may also be tokenized and, in turn, reap the benefits described above. A purpose of the systems, methods, and apparatuses described herein is to help users who are new to banking develop financially sound habits (e.g., paying bills on time, paying bills in-full, managing credit cards, etc.) and improve financial literacy to eventually help their financial situations. For example, in one embodiment, the account management circuit 124 is facilitating monthly savings for purchases made with a credit card, which in essence makes the credit card act as a debit card in that the customer is only spending on purchases for which they have funds available. This is significant because the customer is receiving the benefits of using the credit card (e.g., credit building activity), but the customer can also avoid the pitfalls associated with credit card debt.

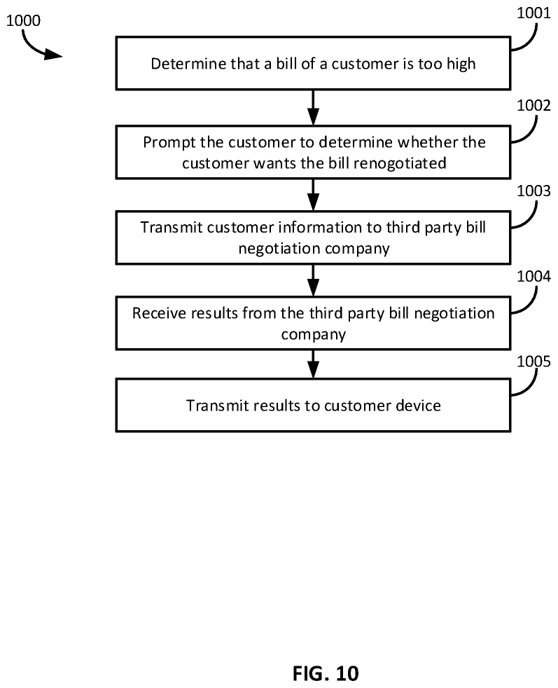

FIG. 10 is method of bill negotiation, according to an example embodiment. This method may be performed, at least partly, by the financial institution computing system 120 such that reference may be made to one more components of the system to aid explanation of the method 1000.

In process 1001, the account management circuit 124 determines a bill of the customers that is ripe for negotiation (e.g., too high, too inconsistent from period-to-period, etc.). In some embodiments, the account management circuit 124 may reference a database of other customers with similar bills and determine that the bill of the customer is too high based on a determined threshold (e.g., median, average, etc.) value of other customers' bills. In some embodiments, the account management circuit 124 may compare the magnitude of each of the bills to a threshold provided from a third party bill negotiation services (e.g., provided via an API). In some embodiments, the threshold is a median value for a representative sample of customers with similar characteristics as the current customer (e.g., geographic location, payee, etc.). In one embodiment, the database may be the accounts database 126 associated with the issuer of the reserve checking account (e.g., the financial institution computing system 120). That is, the accounts database 126 may store information regarding each customer and the customers' respective bills (or some of their bills). The account management circuit 124 may then access the information regarding all of the customers' bills. The account management circuit 124 may then calculate a threshold value for a particular bill by averaging all customers' bills of similar type in similar geographical locations. In some embodiments, the customer may request, via the customer device 110, the account management circuit 124 to determine whether a recurring bill is too high (e.g. as compared to a common value (e.g., threshold) of the industry). For example, the customer may select an icon on the customer device 110 (displayed within the financial institution client application 116) that signals to the account management circuit 124 to check whether the payment amount (e.g., $150) of the cable bill 1202 is too high as compared to other customers.

In one embodiment, a bill negotiation icon may be an add-in and provided on the graphical user interface within the financial institution client application 116. A customer may add the bill negotiation icon manually by selecting preferences within the customer device 110 (e.g., on an application 116 provided by the financial institution computing system 120). For example, the bill negotiation icon may be selectable by the customer and prompt the customer to select certain bills that the customer would like re-negotiated. In another example, the bill negotiation icon may be selectable by the customer that automatically assesses each bill of the customer in response to the customer selecting the bill negotiation icon.

In process 1002, the account management circuit 124 prompts the user to have the selected bill negotiated (down) for the user. The prompt may be facilitated via a sending of a notification to the customer device 110 from the account management circuit 124. The customer may then respond via selecting an option such as “yes” on the customer device 110. In process 1003, the account management circuit 124 transmits information of the bill and the customer to a third party bill negotiation company. In some embodiments, the transmission of the information of the bill and customer may be done via an API between the account management circuit 124 and the third party bill negotiation company. In some embodiments, the account management circuit 124 generates and provides a message, via the network or a direct connection, to the bill negotiation company. The message includes information regarding the bill and the customer (e.g., the name and address of the customer, login information of the customer to the company corresponding to the bill, account number, price currently being paid, a location of the customer, and any other contractual information etc.).

In a process 1004, the account management circuit 124 receives a result from the third party bill negotiation company. In some embodiments, the result is a preliminary assessment from the bill negotiation company. The preliminary assessment may include a likelihood of success of trying to negotiate the bill, information regarding the future process, any fee information, etc. The preliminary assessment may be configured to be displayed on the customer device 110 and prompt the user to respond via the graphical user interface. The customer may respond to the prompt. In some embodiments, the response may instruct the account management circuit 124 to communicate with the bill negotiation company an acceptance of terms and fee for the bill negotiation in order to commence the bill negotiation. In some embodiments, the prompt may be that the bill was determined to be reasonable, thus no more action is required. The third party bill negotiation company may then provide a response to the account management circuit 124 regarding the successfulness of the negotiation. In response to a result that the bill was not successfully negotiated, the account management circuit 124 may document and store the price and result to update a database that may be used when determining whether other bills are too high. In some embodiments, the result is that the bill was successfully negotiated the result may include the amount of money saved because of the negotiation.

In a process 1005, the result of the bill negotiation is sent to the customer device 110. In some embodiments, the account management circuit 124 may then prompt the customer (e.g., via the customer device 110) to ask what the customer would like to do with the amount saved each month. The customer may then select an envelope or account that the customer wants to divert the savings into. The account management circuit 124 may then facilitate the funding of each account based on the diverted savings and corresponding selection from the customer. It is to be appreciated that the financial institution computing system 120 itself may perform any or all steps of the processes described herein. That is, in an alternate embodiment, the financial institution computing system 120 may provide a preliminary assessment based on a database of stored customers' bill information and/or negotiate a bill directly with the service provider.

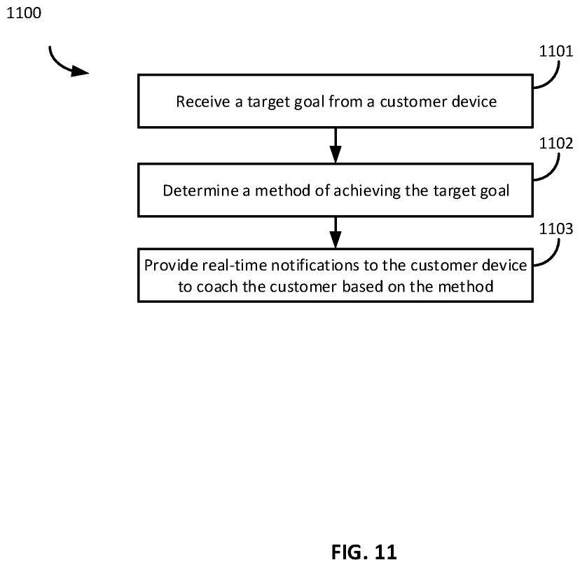

FIG. 11 depicts a method of coaching a user to achieve a goal set by the user (or determined by another). This method may be performed, at least partly, by the financial institution computing system such that reference may be made to one more components of the system to aid explanation of the method 1100.

In process 1101, the account management circuit 124 receives a target goal associated with a customer. In some embodiments, the customer provides the target goal via the financial institution client application 116 on the customer device 110. In some embodiments, the customer is prompted to provide or enter the target goal on the customer device 110. In other embodiments, the account management circuit 124 determines a target coal for the customer based on information regarding the customer (current credit score, account balances, etc.). The target goal may include, but is not limited to, a savings goal, a target credit score, and/or a purchase specific goal. In some embodiments, the purchase specific goal may be associated with and unique to an envelope that acts as a savings account until the envelope has enough money to purchase the desired item. That is, the savings goal may be a savings goal associated with an envelope for “holiday gifts,” “house down payment,” or “new car.” In other embodiments, the savings goal may be associated with the customer reserve account and may be a general savings goal. In some embodiments, the user may select on icon (e.g., on the customer device 110 in the financial institution client application 116). The customer device 110 may then, in response to the selection, display a list of pre-loaded/predefined target goals. The user may then select and enter the target goal into the customer device (in the financial institution client application 116) that the customer would like to achieve. For example, the user may select an icon of “improve my credit score,” the customer device 110 may then prompt the user to enter a defined goal (e.g., credit score of 700) or simply create the target goal of improving the user's credit score in general.

In some embodiments, as mentioned above, the target goal may be predefined by the account management circuit 124 based on information regarding the user. For example, the target goal may be predefined goals to improve a credit score based on an initial credit score and an assessment of the customer's finances. For example, the account management circuit 124 may suggest a target goal to the customer. In some embodiments, the account management circuit 124 may automatically, or nearly automatically, assess a financial situation of a customer. This assessment may be in response to one or more conditions existing, such as the customer having credit score below a predefined threshold value (e.g., below a 700). For example, the account management circuit 124 may monitor the user's spending habits over and account balances over a predefined time period to determine a goal of improving the user's credit score. The account management circuit 124 may then transmit a message to be displayed on the customer device 110 to inquire the customer regarding whether the customer would like to achieve a higher credit score (e.g., above a 700). The customer may then respond on the customer device 110 and the account management circuit 124 may receive the response and transmit a target utilization to be displayed on the customer device 110.

In some embodiments, the account management circuit 124 has a predefined goal for each customer (e.g., target goal of increasing the user's credit score). That is, the account management circuit 124 may have custom recommendations based on the users history, usage patterns, examples of specific implementations are described herein. For example, the account management circuit 124 may monitor the account balances (or credit score) of the user and automatically provide a predefined goal for the user. In an embodiment, the predefined goal may be a target utilization for the user. The target utilization may then be provided from the account management circuit 124 to the customer device to be displayed on a display of the customer device 110 as a notification or displayed within the application 116. The target utilization is the debt-to-credit ratio of the customer that the account management circuit 124 determines may improve the customer's credit score. The account management circuit may calculate or otherwise determine a target utilization for the customer based on one or more formulas, processes, tables, algorithms, equations, and the like. The credit utilization of a customer is defined as the amount the customer owes on all revolving accounts divided by the total amount of credit the customer has on all revolving accounts. The target utilization is what the customer's credit utilization should be in order to improve their credit score. For example, if the customer has a credit availability of $1,000 and the customer is using $300 of the $1,000 credit availability, then the customer has a credit utilization of 30%. In some embodiments, the account management circuit 124 may have determined that a target utilization of 29% is needed in order to increase the credit score of the customer. The target utilization may then serve as a guideline to the account management circuit 124 and the user to help build credit and ease a new user into the credit world. That is, if the account management circuit 124 determines that the user's credit score is below a predefined threshold value and can be improved, the account management circuit may suggest a target utilization value to the customer. In another example, the target utilization could be determined based on other similarly situated customers. For example, in some embodiments, the account management circuit 124 may determine via referencing the accounts database 126 that a first customer has maintained a target utilization for a predefined time period which has increased their credit score. The account management circuit 124 may then determine by comparing the financial situations of the first customer and the user that they have similar financial situations (e.g., similar credit scores, similar amount funds, similar age, similar credit history etc.) The account management circuit 124 may then determine that the target utilization of the first customer should be the target utilization for the user in order to raise the user's credit score.

In a process 1102, the account management circuit 124 determines a method or specific process of achieving the target goal provided by the customer or determined for the customer. With reference to the ongoing target goal example of increasing the user's credit score, the account management circuit 124 may determine that in order to reach a desired credit score, the user should allocate a certain amount of money to paying off a credit account balance. That is, the account management circuit 124 may determine that in order to build credit, the customer should spend a certain amount via a credit card (e.g., and save the money via a savings envelope described above) and then pay the credit card bill in full at the end of the billing cycle. In another example, where the target goal is to achieve target utilization, the account management circuit 124 may determine that the customer has an overall credit utilization that is too high based on a comparison to a threshold value (e.g., over 30%) and determine that the customer should save more money (and/or stop spending on credit) in order to reach the target utilization (and thereby a target credit score). In some embodiments, the account management circuit 124 allocates funds to a revolving credit envelope to save for credit card bill payments in order to reach a calculated or determined target credit utilization (e.g., under 30% of total credit). The account management circuit 124 may calculate or determine the overall credit utilization in real time with the information collected and stored by the account management circuit 124. For example, the account management circuit 124 may have access to all or mostly all of the credit accounts of the customer via an API with each particular credit issuer, access to the customer's credit reports, and/or access to all of the checking and savings accounts of the customer via an API with each particular account issuer. In one example embodiment, the account management circuit 124 may query the credit accounts of the user via the API periodically (e.g., daily, weekly, etc.) and receive the account balance, the credit availability, and the pending charges from each credit account. The account management circuit 124 may then calculate the credit utilization of the user using up-to-date information regarding the user's financial situation (e.g., including from accounts that are not issued from the financial institution computing system 120). That is, in some embodiments, the account management circuit 124 may be able to have an updated real-time financial landscape evaluation of the user and assist the customer by determining how managing money may meet the user's goal.

In a second example, the account management circuit 124 may determine an amount to reach a desired savings goal by a certain date. For example, the account management circuit 124 may determine that the user should allocate $112 per month to a particular envelope in the reserve account and determine where that $112 may come from. For example, the account management circuit 124 may determine that $112 per month may be achieved by reducing the amount of spending on certain items, by lowering bills (e.g., cell phone bills, cable bills, etc.) that are above average, or by canceling services that may not be needed (e.g., cable service). For example, the account management circuit 124 may compare the cable bill of the customer to a database of cable bills of other customers, the account management circuit 124 in response determines that the customers cable bill is too high and can be negotiated lower based on the comparison. In some embodiments, the account management circuit 124 may determine that a purchase specific goal associated with an envelope should receive a percentage of the overall savings from the amount of money left over each month, determine that the purchase specific goal will take a certain amount of time based on the left over money each month, and/or determine that the purchase specific goal is not possible with the current cash flows of the customer. For example, the account management circuit 124 may determine that the user has a certain amount of funds unallocated each month or allocated to a general savings envelope that can be allocated to a specific savings goal (e.g., down payment for a car). The account management circuit 124 may then prompt the user via the application 116 of the customer device 110 as to whether the user would like to place the certain amount (e.g., $124) into a specific savings envelope (e.g., down payment for a car). In another example, the account management circuit 124 may determine that a current savings rate (e.g., automatically determined by the account management circuit 124 or entered by the user) is insufficient for reaching a savings goal in a specified amount of time and, in turn, suggest specific ways to increase the user's savings. In another example, the account management circuit 124 determines that all of the income of the user is currently being allocated to envelopes that cannot be reduced; as such, the account management circuit 124 may then determine (and notify the user by process 1103) that the purchase specific goal is not possible unless the user makes additional changes.

In process 1103, the account management circuit 124 provides the determination of the way of achieving the target goal to the user (e.g., the account management circuit 124 actively coaches the user to achieve the target goal). That is, the account management circuit 124 “coaches” the user via one or more notifications or communications to or via the customer device 110 to achieve the target goal (e.g., coaches the user on their “credit journey.”) “Credit journey” refers to a way of providing credit awareness to the user within the application 116 or via a notification on the customer device 110 that guides the user in improving their credit score (i.e., a pathway that includes hills and valleys representative of one's credit score as he/she proceeds through life and various financial decisions). “Coaching” refers to providing the user with custom and specific advice to help the user achieve one or more specific goals (e.g., improve their credit score, or save) or, more generally, to improve their financial decision making process. In some embodiments, the account management circuit 124 may provide the determination (i.e., coach) via a notification to the customer device 110. The customer device 110 may then present the notification via a graphical user interface generated by the financial institution client application 116 to the customer. The notification may be displayed within the financial institution client application 116 on the customer device or as a push notification on the customer device. The notification may include information that allows the account management circuit 124 to coach or suggest actions to be taken by the user to achieve the target goal. For example, the notification may include the suggestion to cancel a service, reduce a category of spending, reduce credit card balances, or to attempt to lower a current bill. In another example, the customer may have a credit limit of $1000 and a target utilization of 30%, the notification may instruct the user to pay off a calculated sum (e.g., calculated based on the two facts above and the account balances) immediately in order to prevent the user's credit from being impacted. The notification may also include the certain amount of time predicted to reach the target goal. The notification may also include a request to the customer whether the customer would like the account management circuit 124 to implement the way of achieving the target goal. For example, the notification may include “yes” and “no” buttons prompting the customer to respond whether the customer would like the account management circuit 124 to create a new envelope for the purchase specific goal and automatically add a proposed amount of money to the new envelope each month. The notification may also be in response to the customer spending on a credit card and warn the customer that a target credit score (or target utilization) entered by the customer is likely not achievable if the account balance on the credit card exceeds a given value (e.g., 30% of the total credit limit). In some embodiments, the notification may include a target utilization indicator that displays the actual utilization of the customer (e.g., calculated in real time using the cards associated with the checking account issuer, via accessing external credit card accounts via an API, and/or via accessing the customer's credit report via an API) and displaying the target utilization (e.g., the determined utilization necessary to reach a target credit score) next to the actual utilization.

In another example, the account management circuit 124 may be able to interface with a digital assistant (e.g., Siri®) on the customer device 110. For example, the account management circuit 124 may include one or more APIs that enable communication between the application 116 and the digital assistant that is native to the user's device. The account management circuit 124 may provide the notification via the digital assistant. The customer may then verbally interface with the financial institution client application 116 via the digital assistant. The customer may provide instructions via the digital assistant to the financial institution client application 116 that are sent to the account management circuit 124 to automatically adjust the savings goals, payment dates, or payment amounts. The account management circuit 124 may provide the notifications on a periodic basis (e.g., every morning at 8 am).

In some embodiments, the financial institution client application 116 may display an avatar or include a messaging feature providing feedback via a verbal or written communications to the user. For example, the financial institution client application 116 may provide an avatar that can answer questions or perform simple transactions. For example, the user may interface with the avatar and instruct the avatar verbally or manually on the customer device 110 to transfer funds into the customer spend account from a customer savings envelope. The avatar may then send (via the customer device 110) the request to the account management circuit 110, which may then facilitate the transfer of funds from the customer savings envelope to the customer spend account. Further, the avatar may provide a notification (e.g., verbally or textually) that the transfer has been completed. The avatar may also provide an update to the user regarding the customers “credit journey” or how the transfer has affected the user's target goals. For example, in response to the transfer, the account management circuit 124 may determine that the user may not have enough money saved in order to pay off a credit card account or saved for a specific goal. The account management circuit 124 may then send the customer device 110 instructions for the avatar to warn or otherwise notify the user of the financial consequences (or potential consequences) of the transfer based on the specific information that the account management circuit 124 has regarding the recurring bills, credit card balances, and learned behavior. In some embodiments, the user may verbally ask a question to the avatar, or enter a question via the financial institution client application 116, about whether the user has an excess amount of money to make a purchase for a specific item. The user may specify the amount of the purchase and indicate that it is a discretionary purchase. The avatar, or financial institution client application 116 displaying a notification, may respond to the question and indicate whether the customer may make the purchase without hurting the customer's credit score. For example, the customer device 110 may receive the question and send the question to the account management circuit 124. The account management circuit 124 may then determine whether the user has the funds to make the purchase within a reserve account or spend account in order to pay immediately for the item. If the user does not have the funds, the account management circuit 124 may determine that the item will be purchased with credit (or the user may have indicated that the purchase was going to be made with credit). The account management circuit 124 may then estimate the new credit utilization of the user that will result because of the purchase of the item. The account management circuit 124 may then provide back to the user via the financial institution client application 116 or an avatar on the application 116 the estimated financial impact that making the purchase will have and provide a recommendation whether the user should make the purchase. For example, the recommendation would be “no” if the purchase was going to hurt the user's financial situation. In another example, the recommendation may be “yes” if the user has the funds available in the spend account. Similar processes may also be implemented via the digital assistant described above.

In another embodiment, the account management circuit 124 may provide the notification to the customer device 110 at incremental times in order to coach or guide the user to their financial goals. For example, the account management circuit 124 may facilitate a “credit journey” by sending a notification (or periodic notifications) in response to financial activity of the customer. The “credit journey” may be provided by the application 116 that displays a graphical or tabular representation of one or more metrics (e.g., credit score, target utilization, savings goal, etc.) in order to facilitate the management and train the user to become more financially literate and responsible. In one example, the credit journey may include prompts, notifications, or other instructions (e.g., a text bubble, etc.) that may be guidance that the customer is not achieving or achieving (or approaching achievement of) the target goal, as explained above. In other embodiments, the account management circuit 124 may send updates to the customer device 110 to be displayed that show changes over time (e.g., these changes may be displayed graphically or in tabular form as described above) in order to provide relevant information to the customer that would not otherwise be readily available. In this way, the account management circuit 124 can use specific information for each customer, align a strategy to their goals (e.g., via process 1102), and train/coach the user to financial success via customized and specific communications (e.g., to the customer device 110).

In some embodiments, various improvements on computing devices may be implemented in order to achieve the techniques, examples, and custom feedback described throughout the disclosure. For example, the financial institution computing system 120 may utilize machine learning models and artificial intelligence to implement various embodiments described herein. The machine learning models may save information regarding each users (e.g., all users associated with the financial institution) that includes each user's transaction history, bills, amounts of bills, geographic information, user preferences, age, demographic, income, etc. The machine learning model may then correlate various portions of the information to other portions of the information. For example, the machine learning model may correlate all user's in a geographic area to their respective electric bill. The machine learning model may then be used by the account management circuit 124 to predict the seasonality of a new user's electric bill and thereby provide recommendations of funding a corresponding envelope based on the time of year. For example, the machine learning model may determine correlate the month of December in the Midwest to have a 50% increase in typical electric bills. The account management circuit 124 may use this model to notify or advise a new user that is located in the Midwest to save a certain amount more than the user funded the envelope with in November. In another example, the machine learning model may correlate the time of year to a user's spending out of the spending account. That is, in one example, over a year or more of tracking a user's transaction history, the machine learning model may determine that the specific user spends a certain amount (e.g., $1,000) more during holiday months (e.g., November and December). The account management circuit 124 can use this model and correlation to actively guide or advice the specific user to save for these months. For example, in January the account management circuit 124 (e.g., via the notifications or digital assistants described above) may advice the user to set up a separate savings envelope that saves for the certain amount (e.g., $1,000) well before the holiday months arrive. In this way, the financial institution computing system 120 provides an improvement of computing systems (e.g., via the use of complex machine learning models) that may be used by the account management circuit 124 (e.g., via utilizing specific correlations within the complex machine learning models) to provide a benefit (e.g., teaching financial literacy, increasing security, and assisting humans to avoid the many financial pitfalls).

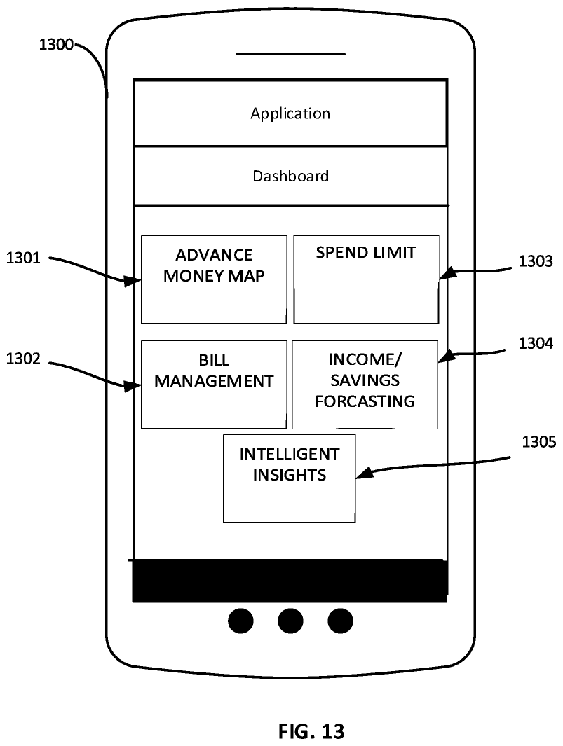

FIG. 13 depicts a dashboard 1300 graphical user interface that may be displayed on the customer device 110 via the client application 116, according to an example embodiment. The dashboard 1300 is one example of how the machine learning models and artificial intelligence created by the financial institution computing system 120 may be utilized to assist or provide valuable information to a customer. For example, the dashboard may provide an icon for a user's advanced money map 1301, spending limit 1303, bill management 1302, income/savings forecasting 1304, and intelligent insights 1305. The advanced money map 1301 icon is selectable by the user and directs the customer device 110 to display items associated with a user's money map. The money map may include customizable categories (e.g., as specific as coffee or more generic, such as groceries), pre-determined categories (e.g., utilities), category spending limits (e.g., similar to the graphical displays discussed above), and tax planning. For example, the money map categories may be calculated by the account management circuit 124 or the customer device 110. The spending limit 1303 icon is selectable by the user and directs the customer device 110 to display items associated with a user's spending limits. The spending limits may include seasonality-based predictions (e.g., based on the models explained above), history-based spending limit adjustments (e.g., how much the user over or under spent in past months), and/or preferences for notifications to be sent to the customer device 110 if a threshold or pattern based on the models is met.

The bill management icon 1302 icon is selectable by the user and directs the customer device 110 to display items associated with a user's bills. The items associated with bills may include bill negotiation (e.g., described above), historical bill data, automatic bill envelope setup (e.g., account management circuit 124 searches for new bills based on recurring charges to set up a new envelope as explained above), and recommended bills based on other users (e.g., based on the machine learning models). The income/savings forecasting icon 1304 is selectable by the user and directs the customer device 110 to display items associated with a user's income and savings forecast. The income and savings forecast may include income modeling (e.g., performed by the account management circuit 124), seasonality-based income predictions (e.g., based on the models and type of work the user does), and provide savings trade-off scenarios (e.g., account management circuit 124 suggests lowering or cancelling bills to meet savings goal as described above). For example, seasonality-based income predictions may be based off the machine learning model of users by industry (e.g., construction workers), geographical location (e.g., Midwest), and specific user historical information to determine the income of the upcoming months (e.g., lower for a construction worker in the Midwest in the winter). The intelligent insights icon 1305 is selectable by the user and directs the customer device 110 to display items associated with a user in general. The items associated with the user in general may include gamification scenarios for expense planning/tracking, peer comparisons, and/or forecasted expenses (e.g., based on recurring items or historical information as described above). For example, the gamification scenarios may include the account management circuit 124 tracking dates of projected income and due dates of bills and generate a scenario of the order in which the user should pay the bills and on which date in order to ensure that the user always has sufficient funds. The peer comparisons may be based on the machine learning models described above or on users in the accounts database 116 and include a comparison of the user to peers that have similar ages, gender, live in the same geographical area, or based on other demographical information.

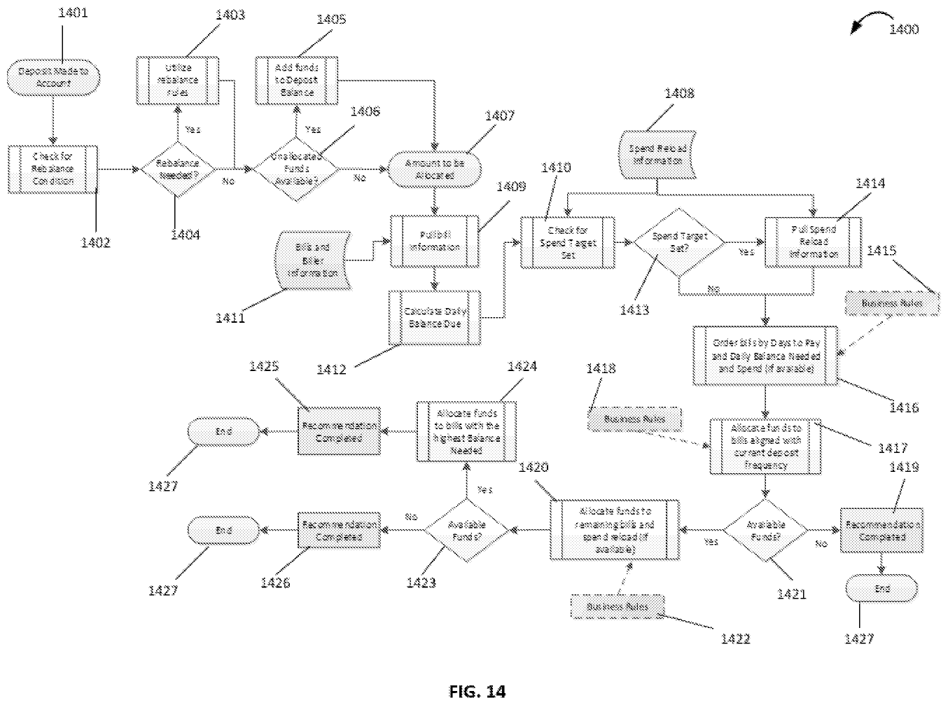

FIG. 14 depicts a flow diagram of a deposit allocation work flow 1400. It is to be appreciated that each of these processes and steps are described in detail throughout the disclosure. FIG. 14 is meant to provide one flow-path for allocating deposits within the two-account structure described herein. These processes of process 1400 may be performed by the financial institution computing system (or, in some embodiments, the mobile device via the client application 116; and, in other embodiments, via a combination of the two) in reaction to receiving a deposit into a specific account of a user. In this example, the process of operating 1400 begins at process 1401 when a deposit is made to the account (e.g., spend account or reserve account). The may be a direct deposit or any deposit of funds into the account. At process 1402, the account management circuit 124 checks each account (spend account and reserve account) and envelope (e.g., within the reserve account) to check for a rebalance. The rebalance determination 124 is represented at process 1404. If the accounts and envelopes need to be rebalanced (i.e., replenished for an upcoming known bill payment), the account management circuit 124 utilizes the rebalance rules (e.g., using spend limits and prioritization management strategy for the spend account as described above) to rebalance the accounts to ensure that the funds are sufficient in each account. At process 1406 the account management circuit 124 may check if there are any funds that were not allocated. At process 1405, the account management circuit 124 adds funds to the deposit balance if they are available to create a total amount that can be allocated at 1407.

The account management circuit 124 may then use the total amount that can be allocated 1407 to pull bill information for the user at process 1409. The account management circuit 124 may utilize one or more API's with the biller's 1411 or account management circuit 124 may determine the amount bill information based on user historical information or entered data as described above. At process 1412 the account management circuit 124 may calculate, estimate, or otherwise determine the daily balance due to each bill. At process 1410, the account management circuit 124 checks if a spend target is set (e.g., details of how are described above). The determination of if the spend target is set is made at process 1413. If the spend target is set, the account management circuit 124 pulls spend reload information 1408 at process 1414 and moves to process 1416. If the spend target is not set, the account management circuit 124 orders all of the user's bills based on days to pay (e.g., due date) and the balance needed to pay for the bills and spending targets of the user in accordance with the rules 1415 specific to the user. At process 1417, the account management circuit 124 allocates funds (e.g., by creating envelopes or funding existing envelopes as described above) to envelopes associated with each bill and to the spend account in accordance with the rules 1418 specific to the user. For example, the account management circuit 1418 will fund envelopes for upcoming bills first. More examples of rules 1417 and business rules 1418 are described throughout various embodiments above.

At process 1421 the account management circuit 124 determines whether more funds are available after funding the envelopes for each “urgent” or upcoming bill. If there are no more funds, then the recommendation is complete at process 1419 and the account management circuit 124 ends the process 1400 at process 1427. If more funds are available, the account management circuit 124 at process 1420 allocates the remaining funds to non-urgent bills (e.g., bills that have much later due dates or savings envelopes) and the spend account (e.g., in accordance with the spend target) based on rules 1422. The rules 1422 for process 1420 are described throughout various embodiments in the disclosure. At process 1423, the account management circuit 124 determines if funds are available after all envelopes and the spend account is funded. If there are no more funds, the process 1400 is complete at process 1426 and the process 1200 is ended at 1427. If there are additional funds after all envelopes and the spend account is funded, then the account management circuit 124 allocates the additional funds to the envelopes with the projected or actual highest balance (e.g., allocate to an envelope for paying off a credit card with a high balance). After the final funds are allocated, the process 1400 is complete at process 1425 and the process 1400 is ended at 1427. It is to be appreciated that any of the processes may include smaller steps such as referencing machine learning models, prompting the user for preferences, or other include any other steps that are described throughout various embodiments in this disclosure.

The embodiments described herein have been described with reference to drawings. The drawings illustrate certain details of specific embodiments that implement the systems, methods, and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network circuits, peripheral devices, input devices, output devices, and sensors. In some embodiments, a circuit may take the form of one or more analog circuits, electronic circuits (e.g., integrated circuits (IC), discrete circuits, system on a chip (SOCs) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example, the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input device,” as described herein, may include any type of input device or input devices including, but not limited to, a keyboard, a keypad, a mouse, joystick, or other input devices capable of performing a similar function. Comparatively, the term “output device,” as described herein, may include any type of output device or output devices including, but not limited to, a computer monitor, printer, facsimile machine, or other output devices capable of performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

What is claimed is:

1. A provider institution computing system associated with a provider institution, comprising:
an accounts database storing information regarding a plurality of accounts associated with a plurality of customers of the provider institution; and
an account management circuit comprising one or more processors communicably coupled to one or more memory devices, the one or more memory devices storing instructions that, when executed by one or more processors, cause the one or more processors to perform operations including:
receiving a customer request to establish an account at the provider institution;
based on the customer request, creating a first account for a customer, the first account having a plurality of envelopes and a unique account number;
receiving information regarding a first expense including an indication of a classification of the first expense and a first payee;
identifying a second expense of the customer based on information regarding a recurring charge of the first account;
establishing a communication channel via an application programming interface (API) with a server associated with a second payee based on the identified second expense;
determining, based on information regarding the second expense received from the second payee via the API, the information regarding the second expense including a second payment amount and a second due date for the second payment amount;
associating the first expense with a first envelope of the plurality of envelopes and the second expense with a second envelope of the plurality of envelopes, the first envelope having a first unique envelope account number different from the unique account number, the second envelope automatically generated based on the identified second expense and having a second unique envelope account number different from the unique account number;
receiving a first payment method preference for the first expense and a second payment method preference for the second expense;
generating a first payment token and a second payment token;
storing the first payment token and the second payment token in the accounts database;
mapping the first payment token and the second payment token to the first account, wherein the first payment token is assigned to the first envelope and the second payment token is assigned to the second envelope, the first payment token configured to facilitate a payment from the first account via the first envelope to the first payee and the second payment token configured to facilitate a payment from the first account via the second envelope to the second payee;
transmitting the first payment token to the first payee and the second payment token to the second payee;
receiving a transaction request from a requestor, the transaction request comprising the first payment token;
determining that the requestor is different than the first payee; and
blocking the transaction request based on a determination that the requestor is different than the first payee.

2. The provider institution computing system of claim 1, wherein the instructions, when executed by the one or more processors, further cause the one or more processors to perform operations including:
associating the first payment token with a first payment rail and the first envelope based on the first payment method preference and associate the second payment token with a second payment rail and the second envelope based on the second payment method preference, wherein the first payment token includes parameters associated with the first payment rail, and wherein the second payment token includes parameters associated with the second payment rail,
wherein the second payment rail is associated with a fee that is less than a fee associated with the first payment rail.

3. The provider institution computing system of claim 1, wherein the instructions, when executed by the one or more processors, further cause the one or more processors to perform operations including:
determining, based on the information regarding the second payee received via the API, information regarding fees, transaction times, and transaction dates associated with the second payee.

4. The provider institution computing system of claim 3, wherein the instructions, when executed by the one or more processors, further cause the one or more processors to perform operations including:
automatically determining, based on the information regarding fees, transaction times, and transaction dates associated with the second payee, a second payment rail for the identified second expense, wherein the determined second payment rail is associated with a second fee that is less than a first fee associated with a first payment rail for the first expense.

5. The provider institution computing system of claim 4, wherein the instructions, when executed by the one or more processors, further cause the one or more processors to perform operations including:
associating the first payment token with the first payment rail and the first envelope based on the first payment method preference and associate the second payment token with the determined second payment rail and the second envelope based on the second payment method preference, wherein the first payment token includes parameters associated with the first payment rail, and wherein the second payment token includes parameters associated with the determined second payment rail.

6. The provider institution computing system of claim 1, wherein the instructions, when executed by the one or more processors, further cause the one or more processors to perform operations including:
determining, based on a risk determination of the second payee, a token governance parameter associated with the second payee; and
replacing, based on the token governance parameter associated with the second payee, the second payment token with a replacement second payment token.

7. The provider institution computing system of claim 1, wherein the instructions, when executed by the one or more processors, further cause the one or more processors to perform operations including:
receiving information regarding a charge of a credit account, the charge including a charge amount;
assigning the charge of the credit account to a third envelope of the plurality of envelopes, the third envelope having a third unique envelope account number different from the unique account number; and
transferring, from a reserve account, funds to the third envelope, the funds having an amount corresponding to the charge amount.

8. The provider institution computing system of claim 1, wherein the instructions, when executed by the one or more processors, further cause the one or more processors to perform operations including:
receiving information regarding a charge of a credit account, the charge including a charge amount;
assigning the charge of the credit account to a third envelope of the plurality of envelopes, the third envelope having a third unique envelope account number different from the unique account number;
determining that the charge amount exceeds an amount of funds in a reserve account linked to the third envelope; and
denying, based on the charge amount exceeding the amount of funds in the reserve account, the charge of the credit account.

9. The provider institution computing system of claim 8, wherein the charge amount is less than a credit limit associated with the credit account.

10. A computer-implemented method, comprising:
receiving, by a provider institution computing system, a customer request to establish an account at an institution associated with the provider institution computing system;
creating, by the provider institution computing system based on the customer request, a first account for a customer, the first account having a plurality of envelopes and a unique account number;
receiving, by the provider institution computing system, information regarding a first expense including an indication of a classification of the first expense and a first payee;
identifying, by the provider institution computing system, a second expense of the customer based on information regarding a recurring charge of the first account;
establishing, by the provider institution computing system, a communication channel via an application programming interface (API) with a server associated with a second payee based on the identified second expense;
determining, by the provider institution computing system based on information regarding the second expense received from the second payee via the API, the information regarding the second expense including a second payment amount and a second due date for the second payment amount;
associating, by the provider institution computing system, the first expense with a first envelope of the plurality of envelopes and the second expense with a second envelope of the plurality of envelopes, the first envelope having a first unique envelope account number different from the unique account number, the second envelope automatically generated based on the identified second expense and having a second unique envelope account number different from the unique account number;
receiving, by the provider institution computing system, a first payment method preference for the first expense and a second payment method preference for the second expense;
generating, by the provider institution computing system, a first payment token and a second payment token;
storing, by the provider institution computing system, the first payment token and the second payment token in an accounts database, the accounts database storing information regarding a plurality of accounts associated with a plurality of customers of the institution;
mapping, by the provider institution computing system, the first payment token and the second payment token to the first account, wherein the first payment token is assigned to the first envelope and the second payment token is assigned to the second envelope, the first payment token configured to facilitate a payment from the first account via the first envelope to the first payee and the second payment token configured to facilitate a payment from the first account via the second envelope to the second payee;
transmitting, by the provider institution computing system the first payment token to the first payee and the second payment token to the second payee;
receiving, by the provider institution computing system, a transaction request from a requestor, the transaction request comprising the first payment token;
determining, by the provider institution computing system, that the requestor is different than the first payee; and
blocking, by the provider institution computing system, the transaction request based on a determination that the requestor is different than the first payee.

11. The method of claim 10, further comprising:
determining, by the provider institution computing system based on the information regarding the second payee received via the API, information regarding fees, transaction times, and transaction dates associated with the second payee.

12. The method of claim 11, further comprising:
automatically determining, based on the information regarding fees, transaction times, and transaction dates associated with the second payee, a second payment rail for the identified second expense, wherein the determined second payment rail is associated with a second fee that is less than a first fee associated with a first payment rail of for the first expense.

13. The method of claim 12, further comprising:
associating the first payment token with the first payment rail and the first envelope based on the first payment method preference; and
associating the second payment token with the determined second payment rail and the second envelope based on the second payment method preference;
wherein the first payment token includes parameters associated with the first payment rail, and wherein the second payment token includes parameters associated with the determined second payment rail.

14. The method of claim 10, further comprising:
determining, based on a risk determination of the second payee, a token governance parameter associated with the second payee; and
replacing, based on the token governance parameter associated with the second payee, the second payment token with a replacement second payment token.

15. The method of claim 10, further comprising:
receiving information regarding a charge of a credit account, the charge including a charge amount;
assigning the charge of the credit account to a third envelope of the plurality of envelopes, the third envelope having a third unique envelope account number different from the unique account number; and
transferring, from a reserve account, funds to the third envelope, the funds having an amount corresponding to the charge amount.

16. The method of claim 10, further comprising:
receiving information regarding a charge of a credit account, the charge including a charge amount;
assigning the charge of the credit account to a third envelope of the plurality of envelopes, the third envelope having a third unique envelope account number different from the unique account number;
determining that the charge amount exceeds an amount of funds in a reserve account linked to the third envelope; and
denying, based on the charge amount exceeding the amount of funds in the reserve account, the charge of the credit account.

17. A non-transitory computer-readable medium storing instructions that, when executed by one or more processors of a provider institution computing system, cause operations comprising:
receiving a customer request to establish an account at an institution associated with the provider institution computing system;
creating, based on the customer request, a first account for a customer, the first account having a plurality of envelopes and a unique account number;
receiving information regarding a first expense including an indication of a classification of the first expense and a first payee;
identifying a second expense of the customer based on information regarding a recurring charge of the first account;
establishing a communication channel via an application programming interface (API) with a server associated with a second payee based on the identified second expense;
determining, based on information regarding the second expense received from the second payee via the API, the information regarding the second expense including a second payment amount and a second due date for the second payment amount;
associating the first expense with a first envelope of the plurality of envelopes and the second expense with a second envelope of the plurality of envelopes, the first envelope having a first unique envelope account number different from the unique account number, the second envelope automatically generated based on the identified second expense and having a second unique envelope account number different from the unique account number;
receiving a first payment method preference for the first expense and a second payment method preference for the second expense;
generating a first payment token and a second payment token;
storing the first payment token and the second payment token in an accounts database, the accounts database storing information regarding a plurality of accounts associated with a plurality of customers of the institution;
mapping the first payment token and the second payment token to the first account, wherein the first payment token is assigned to the first envelope and the second payment token is assigned to the second envelope, the first payment token configured to facilitate a payment from the first account via the first envelope to the first payee and the second payment token configured to facilitate a payment from the first account via the second envelope to the second payee;
transmitting the first payment token to the first payee and the second payment token to the second payee;
receiving a transaction request from a requestor, the transaction request comprising the first payment token;
determining that the requestor is different than the first payee; and
blocking the transaction request based on a determination that the requestor is different than the first payee.

18. The non-transitory computer-readable medium of claim 17, wherein the instructions, when executed by the one or more processors of the provider institution computing system, further cause operations comprising:
determining, based on the information regarding the second payee received via the API, information regarding fees, transaction times, and transaction dates associated with the second payee;
automatically determining, based on the information regarding fees, transaction times, and transaction dates associated with the second payee, a second payment rail for the identified second expense, wherein the determined second payment rail is associated with a second fee that is less than a first fee associated with a first payment rail for the first expense; and
associating the first payment token with the first payment rail and the first envelope based on the first payment method preference and associate the second payment token with the determined second payment rail and the second envelope based on the second payment method preference, wherein the first payment token includes parameters associated with the first payment rail, and wherein the second payment token includes parameters associated with the determined second payment rail.

19. The non-transitory computer-readable medium of claim 17, wherein the instructions, when executed by the one or more processors of the provider institution computing system, further cause operations comprising:
determining, based on a risk determination of the second payee, a token governance parameter associated with the second payee; and
replacing, based on the token governance parameter associated with the second payee, the second payment token with a replacement second payment token.

20. The non-transitory computer-readable medium of claim 17, wherein the instructions, when executed by the one or more processors of the provider institution computing system, further cause operations comprising:
receiving information regarding a charge of a credit account, the charge including a charge amount;
assigning the charge of the credit account to a third envelope of the plurality of envelopes, the third envelope having a third unique envelope account number different from the unique account number; and
transferring, from a reserve account, funds to the third envelope, the funds having an amount corresponding to the charge amount.
